(19) United States
(12) Patent Application Publication
(10) Pub. No.: US 2026/0125775 A1
(43) Pub. Date: May 7, 2026

(54) INTERNAL WATER REUSE IN DIRECT LITHIUM EXTRACTION SYSTEMS

(71) Applicant: Lithos Industries, Inc., dba Element3, Fort Worth, TX (US)

(72) Inventors: Hood H. Whitson, Fort Worth, TX (US); Sarah Hause, Fort Worth, TX (US); Wes Kowalczuk, Johnson City, TN (US)

(73) Assignee: Lithos Industries, Inc., dba Element3, Fort Worth, TX (US)

(21) Appl. No.: 19/427,908

(22) Filed: Dec. 19, 2025

Related U.S. Application Data
(63) Continuation-in-part of application No. 18/601,898, filed on Mar. 11, 2024.
(60) Provisional application No. 63/489,639, filed on Mar. 10, 2023.

(51) Int. Cl. C22B 3/02; C22B 3/22; C22B 3/42; C22B 26/12

(52) U.S. Cl. CPC C22B 3/02; C22B 3/22; C22B 3/42; C22B 26/12

(57) ABSTRACT

Systems and methods are provided for recovering and reusing water generated within a direct-lithium-extraction (DLE) process supplied by a midstream-liquid resource. A DLE system receives a metal-containing fluid and performs a DLE operation to produce (i) a lithium-depleted fluid, (ii) a rinse, and/or (iii) a lithium-concentrate fluid such as a retained rinse or a lithium product in solution. A membrane-separation station operates on a selected process stream to generate a permeate and a retentate. At least a portion of the permeate is reintroduced within the DLE system to support internal water-use functions, including supplying a rinse station as rinse fluid, preparing a reagent solution at a reagent station, and optionally providing water for additional operations such as membrane cleaning, filtration backwash, electrochemical-unit makeup, or general system makeup. At least a portion of the retentate may also be reused within the DLE system, including for alkalinity adjustment, ionic-strength balancing, feed blending, or internal recirculation. By recovering and redirecting water generated from midstream-liquid resources, the system reduces external fresh-water demand, improves resource efficiency, and enhances the operability of DLE deployments in remote or water-constrained environments.

### CROSS-REFERENCE TO RELATED APPLICATION

The present Continuation-In-Part (CIP) Utility Patent Application claims priority to U.S. Non-Provisional Utility patent application Ser. No. 18/601,898, filed on Mar. 11, 2024, and entitled “USE OF SORBENT COMPOSITIONS WITH NANOBUBBLES IN PRODUCED WATER APPLICATIONS,” which claims priority to U.S. Provisional Utility Patent Application No. 63/489,639, filed on Mar. 10, 2023, and entitled “USE OF SORBENT COMPOSITIONS WITH NANOBUBBLES IN PRODUCED WATER APPLICATIONS.” The disclosures of the prior Related Applications are considered part of, and are incorporated by reference into, the present CIP Patent Application.

### TECHNICAL FIELD

In an embodiment, the subject matter relates to direct lithium extraction (DLE) from a midstream liquid resource, including systems and methods for recovering and reusing water generated within a DLE process. A membrane station operates on lithium-depleted rinse fluids, lithium-concentrate rinse fluids, and/or recovered rinse fluids to produce a membrane permeate or retentate that is routed back into the system to a rinse station as a rinse fluid, to a reagent station for preparing a reagent solution, and/or for a variety of other applications, including membrane cleaning, backwashing filtration units, supplying electrolysis-makeup fluid, providing general DLE system makeup fluid, adjusting alkalinity, retaining lithium that would otherwise be lost to disposal, balancing ionic strength, blending with a feed stream, or supporting internal recirculation loops.

### BACKGROUND

Midstream liquid resources, such as oil-and-gas wastewater, produced water, and subsurface brines, can contain lithium alongside dissolved salts, organics, or other constituents. DLE operations seek to selectively transfer lithium from such resources into a lithium-bearing liquid while managing the broader water balance and mass balance of the facility.

Water is used at multiple points in the DLE flow, including rinsing and reagent preparation, membrane cleaning, backwashing filtration units, supplying electrolysis-makeup fluid, providing general system makeup, adjusting alkalinity or ionic strength, and diluting or transporting intermediate process streams. Drawing all such water from external sources can impact logistics and cost, and discharging internal-process liquids can increase handling burdens. In some operating regions, such as arid basins including portions of the U.S. State of Texas where produced water may contain lithium, naturally available freshwater is limited, increasing the value of reliable onsite water sources.

In geothermal operations, circulating geothermal brines can mobilize lithium from reservoir formations and return lithium in the produced geofluid. Such brines are typically recirculated after heat exchange and may exhibit elevated total dissolved solids with species including, for example, silica and other dissolved minerals. A side stream of geothermal brine is directed to a DLE unit to selectively transfer lithium into a lithium-concentrate fluid while producing a lithium-depleted fluid for reinjection or further treatment. Integrating DLE with geothermal facilities may provide an additional revenue stream and increase the economic attractiveness of geothermal installations by leveraging existing wells, power, and surface infrastructure, while accommodating reinjection requirements, materials compatibility, scaling propensity, and variability in feed composition.

### SUMMARY

For reasons outlined above, including water use at multiple points in the DLE flow, limited freshwater availability in certain geographic operating regions, and opportunities presented by geothermal and other resources, there remains a need for a reliable, controllable water source to support direct lithium extraction.

One or more embodiments of the present disclosure relate to methods and systems for enhancing the extraction of lithium from midstream liquid resources. An embodiment addresses the need for effective pre-treatment, rinsing, and polishing processes to ensure the efficient removal of impurities and enhance lithium extraction. An embodiment also enables the generation of reagents onsite and sustainably provides water for system maintenance.

An embodiment of the present disclosure includes a method for recovering a fluid during operation of a direct-lithium-extraction (DLE) system. The method includes recovering a process stream selected from a lithium-depleted fluid, a rinse, or a lithium-concentrate fluid; performing membrane separation on the recovered process stream to produce a permeate and a retentate; and reintroducing at least a portion of the permeate or retentate for reuse within the DLE system. In some embodiments, reintroduction includes supplying permeate as a constituent of a rinse fluid or for preparing a reagent solution. In other embodiments, reintroduction includes using retentate within the DLE system for internal reuse.

Another embodiment is a system configured to recover and reuse fluids produced within a DLE operation. The system includes a DLE unit configured to produce a lithium-depleted fluid and/or a lithium-concentrate fluid, a membrane station configured to generate a permeate and a retentate from at least a stream of one of these fluids, and one or more stations configured to receive the permeate for preparation of rinse fluids or reagent solutions. In some embodiments, the system further comprises vessels, routing connections, blending equipment, monitoring systems, or controllers enabling selective routing, reuse, or distribution of permeate or retentate.

In some embodiments, the DLE operation comprises ion-exchange or adsorption using a sorbent composition, and lithium is placed into solution during a rinse or elution step. In other embodiments, the DLE operation comprises membrane-based separation producing a lithium-rich aqueous solution. Further embodiments include electrochemical DLE operations in which a lithium product in solution is produced downstream of an electrochemical extraction unit or during a rinse step.

In embodiments relating to recovery of process streams, a recovered stream may include batch- or continuous-process streams, lithium-bearing eluates produced at reagent stations, or liquids removed from sorbent compositions after a contact time. The recovered stream may include a rinse retained after a rinse step or a post-loading rinse, and in some embodiments a recovered rinse contains little or no lithium while remaining suitable for membrane separation.

In embodiments relating to membrane separation, the membrane station may perform reverse osmosis, nanofiltration, forward osmosis, or osmotically assisted membrane processing. In some embodiments, a lithium-concentrate fluid is introduced at a temperature, conductivity, ionic-strength range, or pH compatible with membrane operation. Membranes may include tubular membranes, spiral-wound membranes, flat-sheet membranes, or osmotically assisted membranes. In some embodiments, permeate and retentate are collected into separate vessels for further processing, reuse, blending, or distribution. Lithium-concentrate fluids may include retained rinses, lithium products in solution, lithium brine concentrates, or lithium-rich solutions containing lithium chloride, lithium sulfate, or lithium carbonate.

In embodiments relating to polishing, at least one of the permeate or retentate may be polished using mechanical, chemical, biological, or membrane-based techniques. Mechanical polishing may include sand-bed filters or carbon filters using granulated, powdered, extruded, impregnated, fibrous, catalytic, or biochar forms of carbon media. Chemical polishing may include ion-exchange media such as zeolite, manganese greensand, or synthetic resins. Membrane polishing may include ultrafiltration, nanofiltration, reverse osmosis, or divalent-rejection membranes of polymeric or ceramic construction. In some embodiments, polishing supports compliance with reuse specifications applied before reintroducing streams into the DLE system.

In embodiments relating to reuse of permeate, permeate may serve as at least a portion of a rinse fluid, a reagent diluent, a membrane-cleaning fluid, a backwash fluid, an electrolysis-makeup fluid, or a general DLE-system makeup fluid. In embodiments relating to reuse of retentate, retentate may be used to adjust alkalinity, retain lithium, maintain or adjust ionic strength, blend with a feed stream, or circulate within an internal loop to reduce waste volume or enhance separation efficiency.

In embodiments relating to monitoring and control, reuse may be conditioned on meeting a reuse specification including TDS and pH bounds. Monitoring systems may measure solution quality at one or more points, and controllers may actuate valves, allocate permeate between rinse and reagent stations, proportion permeate with fresh water, or reduce fresh-water draw in response to increased internal permeate availability. The system may operate in batch or continuous modes.

In embodiments relating to pre-treatment and routing, the system may include a pre-treatment station configured to produce a filtrate constituting at least a portion of the midstream liquid resource supplied to the DLE unit. The system may include routing connections configured to send retained rinses or lithium-bearing solutions to the membrane station, bypass conduits for supplying permeate directly to reuse points, vessels for blending permeate with fresh water, or holding tanks for receiving retentate for further processing or disposal. In some embodiments, selectable routing connections enable lithium-depleted fluids, post-loading rinses, or lithium-concentrate fluids to serve as feed to the membrane station. Additional embodiments include polishing units configured to remove divalent cations or hydrocarbons from permeate or retentate.

Additional embodiments can include any of the foregoing features in combination or subcombination, unless explicitly stated otherwise. The embodiments or aspects described herein are not limiting, and various features may be practiced independently or in combination or subcombination across the method and system embodiments.

### BRIEF DESCRIPTION OF THE DRAWINGS

FIG. 1 is a workflow diagram of a method of operation of a system for reducing the concentration of at least one metal in a liquid resource, according to some embodiments of the present disclosure.

FIG. 2 is a flowchart of a method for reclaiming and reusing water within a direct-lithium-extraction (DLE) facility, according to some embodiments of the present disclosure.

FIG. 3 is a flowchart of a method for extracting a metal from a midstream liquid resource, according to some embodiments of the present disclosure.

FIG. 4 is a flowchart of a method for enhancing or optimizing extraction of lithium from a liquid, according to some embodiments of the present disclosure.

FIG. 5 is a block diagram of a system for enhancing or optimizing extraction of a metal from a liquid, according to some embodiments of the present disclosure.

FIG. 6 is a block diagram of a system, such as the system of FIG. 5, for enhancing or optimizing extraction of a metal from a liquid, and of a treatment station of the system, according to some other embodiments of the present disclosure.

FIG. 7 is a block diagram of a system, such as the system of FIG. 5, for enhancing or optimizing extraction of a metal from a fluid, and of a treatment station of the system, according to yet some other embodiments of the present disclosure.

FIG. 8 is a block diagram of a system, such as the system of FIG. 5, for enhancing or optimizing extraction of a metal from a liquid, and of a critical metal extraction (CME) system, according to some embodiments of the present disclosure.

### DETAILED DESCRIPTION

In some embodiments, a liquid resource may be produced water. Produced water generally can be defined as any water produced concurrently with the production of oil and gas hydrocarbons from underground reservoirs or subterranean flows, including, but not limited to, naturally occurring formation water, flow-back water, recycled water, or water injected into reservoirs during hydraulic fracturing or other injection methods. While produced water has been provided as an example application within the present disclosure, the present disclosure is broadly applicable to any subsurface fluid containing a metal. Non-limiting examples of a subsurface fluid containing a metal include brines produced from hydrocarbon reservoirs exclusively for metal extraction or as a secondary application (e.g., extracting a metal from a geothermal brine). Some embodiments of the present disclosure may be utilized to extract a metal or metals of interest from a recycle pit or other holding tank or pond on the surface.

One or more embodiments of the present disclosure are useful to existing hydrocarbon-extraction processes in several ways. One or more embodiments can be applied across all types of oil and gas recovery. Some embodiments may be applied to primary recovery, where a well for hydrocarbon is drilled either vertically or horizontally. Upon well completion, in certain geographical areas and producing zones, natural water flow is sufficient in quantity and with viable concentrations of valuable materials for removal of retentate.

“Fluid oil and gas waste” refers to waste containing salt or other mineralized substances, brine, hydraulic-fracturing fluid, flowback water, produced water, or other fluid that arises out of, or is incidental to, the drilling for production of oil or gas. Midstream-liquid resources, such as produced water, can play a crucial role in the ecosystem of direct lithium extraction (DLE). As a byproduct of oil and gas extraction, produced water and its management can be essential for both environmental and operational efficiency.

Produced water is generally defined as any water produced concurrently with the production of oil and gas hydrocarbons from underground reservoirs or subterranean flows, including, but not limited to, naturally occurring formation water, flowback water, recycled water, or water injected into reservoirs during hydraulic fracturing or other injection methods. While produced water has been provided as an example application within the present disclosure, the present disclosure is broadly applicable to any subsurface fluid containing a metal. Non-limiting examples of a subsurface fluid containing a metal include brines produced from hydrocarbon reservoirs exclusively for metal extraction or as a secondary application (e.g., extracting a metal from a geothermal brine). In some embodiments, the present disclosure may be utilized to extract a metal or metals of interest from a recycle pit or other holding tank or pond on the surface.

Midstream treatment facilities, including pipeline-access points, disposal sites, midstream-recycling plants, and desalination plants, play roles in processing produced water.

When produced water reaches the surface of the ground, it often contains a wide array of chemicals and substances. Some chemicals are native to the subsurface formation, while others are introduced during the oil-and-gas extraction process, while more chemicals can be added to maintain infrastructure and support transport in pipeline infrastructure. Additional chemicals and treatment regimens can be applied to the produced water to remove hydrocarbons, organic matter, hydrogen sulfide, ions, or suspended solids. The chemical and physical-property requirements of produced water vary along the life cycle of the produced water. For exemplary purposes, the standard of treatment of produced water can range from no more treatment than the application of a biocide to applying more-complex treatment regimens to remove toxins, heavy metals, and dissolved solids from the produced water.

In some embodiments, the pre-treated midstream-liquid resource may initially have an Oxidation-Reduction Potential (ORP) of approximately 100 millvolts (mV). Following the application of a second treatment regimen, which may include the introduction of a biocide, the ORP can increase to values as high as 650 mV. ORP values ranging from 0 mV to 650 mV typically indicate an oxidative environment. Such positive ORP values are generally recognized as sufficient to inhibit microbial growth, thereby rendering the pre-treated midstream-liquid resource biologically inactive. Applying a second treatment regimen to the pre-treated midstream-liquid resource having an ORP value of 200 mV may increase the ORP up to 450 mV. Such an increase may be desirable to inhibit microbial growth.

The varying quality of produced water complicates valuable midstream treatments like Direct Lithium Extraction, the performance of which can be reduced by the contents of a midstream-liquid resource. To further illustrate the varying quality of produced water, consider the following:

### Pipeline

Produced water typically finds its way to midstream sites as a midstream-liquid resource through a well-coordinated network of pipelines and transportation logistics. Midstream-liquid resources typically are extracted with hydrocarbons and are separated from the oil and gas at the wellhead. The initial separation process may involve basic treatment to remove free oil and large particulates from the produced water. At the ground surface, additional chemical treatments can be added to the midstream-liquid resource. Examples of treatments include chelating agents, friction reducers, corrosion inhibitors, scale inhibitors, demulsifies, paraffin inhibitors, hydrate inhibitors, pH adjusters, biocides, coagulants, flocculants, surfactants, or anti-foaming agents.

These individual treatments and combinations of individual treatments used in midstream-liquid-resource treatment regimens can pose several challenges for the extraction of critical metals, such as lithium in Direct Lithium Extraction. Non-limiting examples of treatments used in a midstream-liquid resource that can significantly impact the performance of the extraction of critical metals include sorbents, ion-exchange resins, or lithium-selective membranes used in direct-metal-extraction processes like direct-lithium-extraction (DLE) processes. These impacts may manifest through fouling, chemical interactions, or degradation of materials.

For example, chelating agents, such as EDTA, are introduced into the produced water to bind metal ions and prevent scale formation. However, these agents also can bind to essential ions used in sorbents and resins, reducing their capacity to selectively capture lithium ions. For lithium-selective membranes, chelating agents can form stable complexes that clog membrane pores, reducing permeability and selectivity. In some embodiments, when the metal-extraction system is an electrochemical Direct-Lithium-Extraction (DLE) system, chelating agents can bind to lithium ions, forming complexes that reduce the availability of free lithium for extraction. This binding can decrease the efficiency of the electrochemical process, as the system relies on the selective movement of lithium ions. In some embodiments, chelating agents may compete with other metal ions in the produced-water solution, potentially altering the effectiveness of membranes and electrodes and reducing lithium-recovery rates. These agents also can interact with the materials used in the system, causing fouling or degradation, which can decrease the overall efficiency and lifespan of the equipment.

When friction reducers like polyacrylamides (PAM) are present in a midstream-liquid resource, they can impact significantly the performance of these membrane systems. PAM and similar polymers can adhere to the membrane surface, forming a coating that blocks pores, leading to fouling. This fouling typically increases the pressure drop across the membrane, requiring more energy to maintain flow rates and ultimately reducing the efficiency of the filtration process. In lithium-selective membranes, such as those used in DLE systems, this fouling can be particularly detrimental as it diminishes the selective permeability of the membrane, reducing lithium-recovery rates. Additionally, these friction reducers can coat sorbents and resins used in ion-exchange processes, decreasing their effectiveness, and can interfere with electrochemical DLE processes by altering the conductivity and flow characteristics of the treated fluids. The presence of friction reducers like PAM in low ppm concentrations can be challenging to detect, further complicating the maintenance, enhancement, or optimization of these sensitive systems.

Friction reducers, typically polyacrylamides (PAM), can be used to minimize resistance within pipeline systems. These polymers can form coatings on sorbents and resins, leading to fouling and decreased efficiency. For example, when these polymers adhere to lithium-selective membranes, they can block pores and increase pressure drops, thereby diminishing the membrane's performance. This issue is not limited to lithium-selective membranes; non-selective membranes, such as ultrafiltration, nanofiltration, and microfiltration membranes, also can be impacted. These membranes are often used in pre-treatment and filtration processes to remove suspended solids, organic matter, and other impurities before the fluid reaches more-sensitive stages of processing. Regardless of the membrane's selectivity, friction reducers can greatly reduce overall system efficiency by causing membrane fouling, leading to increased maintenance and operational costs. While friction reducers like PAM can have substantial negative impacts on sensitive DLE systems, they can be difficult to detect, and even when present, ppm concentrations of friction reducers can be challenging to determine.

Corrosion inhibitors, such as phosphonates, can protect metal surfaces from corrosion. However, they can deposit on sorbents and resins, leading to fouling. On lithium-selective membranes, these inhibitors can form protective films that block ion-transport channels, reducing the membrane's effectiveness in lithium separation. Scale inhibitors, like phosphonates and polyacrylates, typically prevent scale formation but can interact negatively with sorbents and resins by forming precipitates that block active sites. Regarding lithium-selective membranes, these inhibitors can deposit and cause scaling, which can reduce membrane efficiency, increase downtime, or further contribute to costly maintenance requirements.

Demulsifiers typically break emulsions into separate oil and water phases. They can introduce organic contaminants that adsorb onto sorbents and resins, causing fouling and reducing their ion-exchange capacities. These organic contaminants also can form fouling layers on lithium-selective membranes, impairing their function. Paraffin inhibitors typically prevent paraffin deposition but can adhere to sorbents and resins, causing fouling. On lithium-selective membranes, these inhibitors can coat the surface, reducing permeability and selectivity by blocking the pores typically deemed essential for lithium-ion transport. Hydrate inhibitors, such as methanol, can introduce organic loads into produced water, leading to fouling of sorbents and resins. These organic compounds also can cause fouling on lithium-selective membranes, reducing their efficiency and lifespan. pH adjusters, such as sodium hydroxide and sulfuric acid, can be used to control the pH levels of produced water. Extreme pH conditions can degrade the materials of sorbents and resins, reducing their capacities and effectiveness. For lithium-selective membranes, both highly acidic (e.g., pHs below 3) and highly basic conditions can hydrolyze the membrane material, leading to structural damage and reduced performance.

Biocides, for example oxidizers like chlorine and hydrogen peroxide, can be used to disinfect produced water. Oxidizers may attack the polymeric material of lithium-selective membranes, leading to loss of selectivity and increased degradation rates. Coagulants, such as aluminum sulfate, can be used to aggregate fine particles into larger ones for easier removal. These coagulants can form precipitates on sorbents and resins, blocking active sites and reducing capacity. On lithium-selective membranes, coagulated particles can clog the pores, reducing permeability and increasing operational costs.

Several flocculants may be present in a midstream-liquid-resource system. Non-limiting examples of flocculants include Polyacrylamide (PAM), Polyethyleneimine (PEI), PolyDADMAC (Polydiallyldimethylammonium chloride), Polyamines, starch-based flocculants, Chitosan, Alum (Aluminum Sulfate), Ferric Chloride, Ferric Sulfate, or Calcium Hydroxide (Lime). Flocculants, like polyacrylamides, aggregate suspended particles. They can create large flocculant aggregates that block the pores of sorbents and resins, leading to fouling. Similarly, these aggregates can block the pores of lithium-selective membranes, reducing their selectivity and effectiveness. Flocculants can impact Direct Metal Extraction (DME) systems, particularly those involving sorbents, ion-exchange resins, or membranes. In systems utilizing sorbents, flocculants may cause the aggregation of suspended solids, leading to fouling or clogging of the sorbent materials, thereby reducing their efficiency in selectively adsorbing lithium ions. For ion-exchange resins, flocculants can interfere by binding with other ions or organic materials, which binding can decrease the resin's capacity for lithium exchange and hinder overall system performance. When it comes to membranes, including lithium-selective and other types, flocculants can cause fouling that obstructs the flow of liquids through the membrane, reducing its effectiveness and potentially leading to increased maintenance needs or operational costs. In electrochemical DLE systems, the presence of flocculants can exacerbate further these issues by interfering with the selective transport of lithium ions, diminishing recovery rates, and requiring more-frequent cleaning or replacement of membrane and electrochemical components. This combined impact can significantly reduce the operational efficiency or economic viability of the DLE process.

Surfactants, such as sodium dodecyl sulfate (SDS), can reduce surface tension and emulsify oils. Non-limiting examples of surfactants include the surfactant being at least one of polyethylene glycols (PEGs), alcohol ethoxylates, linear alkyl ethoxylates (LAEs), sodium dodecyl sulfate (SDS), sodium lauryl sulfate (SLS), octylphenol ethoxylates (OPEOs), nonylphenol ethoxylates (NPEOs), alkyl polyglycosides (APGs), cocamidopropyl betaine, saponins, glycolipids, or rhamnolipids. Surfactants within a midstream fluid can form micelles that adhere to sorbents and resins, causing fouling and reducing ion-exchange capacities. On lithium-selective membranes, surfactants can form micelles that block pores and reduce membrane efficiency. Non-limiting examples of surfactants include, but are not limited to, polyethylene glycols (PEGs), alcohol ethoxylates, linear alkyl ethoxylates (LAEs), sodium dodecyl sulfate (SDS), sodium lauryl sulfate (SLS), octylphenol ethoxylates (OPEOs), nonylphenol ethoxylates (NPEOs), alkyl polyglycosides (APGs), cocamidopropyl betaine, saponins, glycolipids, or rhamnolipids.

Anti-foaming agents, often silicone-based, can be used to reduce foam formation. These agents can introduce hydrophobic substances that foul sorbents and resins, reducing their effectiveness. On lithium-selective membranes, these hydrophobic layers can block pores, leading to decreased permeability and increased maintenance needs.

### Midstream Treatment Process

Following the above-described treatment (sometimes called “pre-treatment”), in an embodiment the midstream-liquid resource is transported via pipelines to centralized midstream facilities for further treatment. In some cases, tanker trucks are used, especially when pipelines are not feasible. These midstream sites, including disposal facilities, transfer facilities, treatment plants, storage tanks or ponds, recycling facilities, or desalination plants, are strategically located to handle large volumes of produced water efficiently. Sometimes these locations are equipped with advanced technologies to treat the water, remove contaminants, and extract valuable metals, like lithium. This system can ensure that produced water is managed effectively, minimizing environmental impact and enabling resource recovery.

The midstream-liquid resource may contain a complex mixture of organic and inorganic substances, some of which include:

Water: Throughout this disclosure, the term “water” includes aqueous fluids that may contain dissolved salts, chemical additives, treatment by-products, gases, or other constituents. Water streams within DLE systems frequently contain non-zero TDS, non-neutral pH, and other physical-chemistry attributes, and therefore may be referred to as acidic or basic solutions. As used herein, “water” encompasses such aqueous mixtures unless explicitly stated otherwise.

Water removal, water recovery, and water concentration: references to “water removal,” “water recovery,” or “water concentration” refer to removing at least a portion of the aqueous solvent from an aqueous fluid, including permeate, retentate, rinse liquids, eluates, and polishing streams that contain dissolved or suspended solids, ions, acids, bases, or other constituents. In some embodiments, such removal may increase the concentration of lithium or other solutes in the remaining fluid. The term “water” is used broadly and includes impure, chemically conditioned, pH-adjusted, or otherwise-treated aqueous fluids, and does not require that all water be removed from a fluid for the process to constitute “water removal.”

Salts: High levels of total dissolved solids (TDS) range from 50,000 to over 250,000 ppm. Non-limiting examples of inorganic substances associated with salt include sodium chloride (NaCl), which is commonly present as table salt in significant quantities, calcium sulfate (CaSO₄), also known as gypsum, which can precipitate and cause scaling, magnesium chloride (MgCl₂), which can contribute to the hardness of water and scaling potential, and bicarbonates (HCO₃), which also can contribute to scaling issues.

Flocculants: Used in various stages of water treatment to aggregate and remove suspended particles from the liquid resource. These chemicals aid in the coagulation and flocculation processes, where small particles are bound together to form larger aggregates that can be more easily removed by mechanical-filtration techniques. Non-limiting examples of flocculants that may be present in the midstream-liquid resource include polyacrylamide (PAM), polyethyleneimine, polyamines, polyDADMAC (polydiallyldimethylammonium chloride), starch-based flocculants, or chitosan. The presence of flocculants can critical for effective separation and treatment processes but can pose challenges in downstream processing, particularly in sensitive operations like critical-material extraction, where they can interfere with sorbents, ion-exchange resins, or membranes.

Metals: Trace amounts of metals are often found in produced water. While some such metals are desirable, like lithium, which can be concentrated through advanced processing, others, like iron, are removed to support further processing or beneficial reuse.

Hydrocarbons: Residual oil and grease from the oil-and-gas extraction process.

Chemicals: Additives such as flocculants and surfactants used in drilling and hydraulic-fracturing operations may be present in the midstream-liquid resource. In primary recovery, chemicals like demulsifiers are used to break emulsions formed between oil and water. During secondary recovery, water flooding can introduce scale inhibitors and corrosion inhibitors to protect equipment and pipelines. In tertiary recovery, also known as enhanced oil recovery (EOR), a variety of chemicals may be introduced, including surfactants, polymers, or alkaline agents, to reduce interfacial tension and increase oil mobility. These chemicals can be broadly categorized into organic, inorganic, and biological classes, each with distinct roles and effects on the recovery process. For instance, surfactants (organic compounds) can be used to reduce the interfacial tension between oil and water, facilitating the movement of oil through the reservoir. Polymers, often organic, can be injected to increase the viscosity of the displacing water, improving its ability to push oil towards production wells. Alkaline agents, typically inorganic, can be used to react with acidic components in the crude oil, generating in-situ surfactants that further aid in oil recovery.

Additionally, carbon dioxide (CO2) or steam injection, common EOR methods, may leave residual chemicals that affect water chemistry. Paraffin inhibitors are often used throughout these processes to prevent wax deposition, which can clog pipelines and equipment. Biological EOR methods, such as microbial-enhanced oil recovery (MEOR), can introduce specific strains of bacteria to metabolize heavy hydrocarbons or generate gas, aiding in the displacement of oil. These treatments, while often performing essential functions, often result in trace compounds remaining in midstream-liquid resources that, when subjected to traditional disposal methods, can persist at levels that significantly impact the effectiveness of critical-metal-extraction systems. These chemicals, along with residuals from earlier stages, can contribute to the complexity of treating and processing the midstream-liquid resource.

Chemical treatments such as oxidizers, including chlorine dioxide and sodium hypochlorite, are frequently used to break down organic contaminants and neutralize hazardous compounds, leaving byproducts such as chlorinated organic compounds. Coagulants and flocculants, applied to aggregate and remove suspended solids, may result in residual flocculated particles that require further filtration. Biocides, applied to control microbial growth, can leave byproducts such as dead biomass and organic residuals that may contribute to biofouling in subsequent processing stages. Additionally, bioremediation efforts using bacteria or enzymes to degrade hydrocarbons may produce metabolic byproducts like organic acids and gases, further complicating the treatment of the midstream-liquid resource. These chemicals and their byproducts can contribute to the complexity of treating and processing the midstream-liquid resource.

Biocides and Corrosion Inhibitors: Can be used to prevent microbial growth and equipment degradation.

Other Contaminants: After pre-treatment, the midstream-liquid resource may still contain a variety of chemicals and compounds. These can include suspended solids, such as fine particulate matter that was not fully removed during the initial filtration steps. Iron is often present as both dissolved and particulate forms, which can contribute to scaling and corrosion if not adequately treated. Hydrogen sulfide (H₂S), a toxic and corrosive gas, may remain in the liquid and pose safety and handling challenges. Additionally, residual chemicals from earlier stages of treatment, such as biocides, corrosion inhibitors, or friction reducers, can persist in the midstream-liquid resource. Trace amounts of scale inhibitors, demulsifiers, paraffin inhibitors, or pH adjusters also may be present, each contributing to the complexity of further treatment or further extraction processes. These residual contaminants typically are carefully managed to ensure the effectiveness of subsequent processing steps, such as critical-material extraction.

### Water Quality: Total Dissolved Solids (TDS)

The Total Dissolved Solids (TDS) content in midstream-liquid resources can vary significantly between different geological formations and even within the lifecycle of a well. Total dissolved solids (TDS) and conductivity may be used interchangeably, as conductivity measurements typically provide a direct proxy for TDS and are routinely converted to TDS values in water-quality monitoring. For illustrative purposes, the midstream-liquid resource may be further characterized by one or more water-quality metrics. Non-limiting examples of water-quality metrics in some embodiments include turbidity, Total Suspended Solids (TSS), Oxidation-Reduction Potential (ORP), or the midstream-liquid resource may be characterized by the presence of heavy metals, like iron, or compounds like H₂S in mg/L. For example, a turbidity level of at least 100 Nephelometric Turbidity Units (NTU), a Total Suspended Solids (TSS) of at least 100 mg/L and at least one of a negative Oxidation-Reduction Potential (ORP) to up to +200mV, and an iron content greater than 5 mg/L, may be used to characterize a midstream-liquid resource. The following ranges are provided by United States Geology Survey (USGS) resources available at the time of filing and demonstrate the variability in ways midstream-liquid resources are described:

Smackover Formation: In the Smackover formation, the TDS content in midstream-liquid resources has been observed to range from a minimum of 1,230 mg/L to a maximum of 377,000 mg/L. This substantial range indicates the highly variable nature of water quality in this formation.

Cotton Valley Formation: For the Cotton Valley formation, the TDS content ranges from a minimum of 5,241 mg/L to a maximum of 366,666 mg/L. This wide range reflects the diverse conditions and compositions encountered in different parts of the formation.

Wolfcamp Formation: The Wolfcamp formation exhibits a TDS range from 60,950 mg/L to 248,000 mg/L. Additionally, there is data indicating that TDS levels can vary within the same well, with some batches testing as low as 2,000 mg/L and as high as 140,000 mg/L in other instances. All references to the geochemical insights and related data provided herein are to the article titled ‘Geochemical insights from formation waters produced from Wolfcampian and Leonardian intervals of the Midland Basin, Texas, USA,’ which is incorporated by reference herein in its entirety and is located at https://www.sciencedirect.com/science/article/abs/pii/S088329272300029X.

Spraberry Formation: In the Spraberry formation, TDS levels range from 82,430 mg/L to 184,622 mg/L. This range highlights the varying water quality that can be expected from different extraction points within the formation.

Bone Spring Formation: The Bone Spring formation shows a TDS range from 60,000 mg/L to 300,000 mg/L. Similar to other formations, this range indicates substantial variability in water composition, which can affect the treatment processes.

The Haynesville Shale formation is known for its significant variability in Total Dissolved Solids (TDS) concentrations, which range from approximately 5,000 ppm to 250,000 ppm. This broad range in TDS is indicative of the formation's complex geology and the varying water chemistry encountered at different depths and locations within the formation, as well as different time periods during the life of the well. Such variability can pose challenges for water-management and water-treatment strategies, particularly in operations that involve hydraulic fracturing or water recycling. The presence of high TDS levels often necessitates advanced water-treatment processes to remove salts or other dissolved solids to make the water suitable for reuse or safe disposal. In its entirety, the disclosure of the article ‘Water Resources and Water Management in the Haynesville Shale’ from the GoHaynesvilleShale website, accessible at GoHaynesvilleShale, is incorporated herein by reference.

As an example of how TDS may vary at depth, consider the Eagle Ford formation, where in contrast to Spraberry-Wolfcamp, TDS levels show a reversal of total dissolved solids with depth. Eagle Ford levels range from 18,000-200,000 TDS. In its entirety, the disclosure of “Salinity Reversal and Water Freshening in the Eagle Ford Shale, Texas, USA,” authored by Peter L. Knappett, et al., and published in ACS Earth and Chemistry Chemistry, Vol. 2, No. 9, Pages 872-883, DOI:10.1021/acsearthspacechem.8b00095, is incorporated herein by reference.

The Bakken formation exhibits a Total Dissolved Solids (TDS) up to 275,160 ppm. This high TDS value can indicates the significant presence of dissolved salts and other minerals in the formation's water, which reflects the deep and ancient nature of the reservoir. Managing and treating such high-TDS water can be challenging, often requiring advanced water-management techniques to make the water usable for various industrial purposes or safe for disposal.

The Barnett Shale, another prominent formation, displays an even broader TDS range, from 170,070 ppm to 295,280 ppm. This substantial variability in TDS levels across the Barnett formation highlights the diverse geochemical conditions present within the formation. Similar to the Bakken, the high TDS levels in the Barnett Shale can necessitate specialized water-treatment strategies to handle the concentrated levels of dissolved minerals, ensuring that the water can be reused or disposed of appropriately.

The above-disclosed TDS ranges illustrate the challenges faced in treating midstream-liquid resource from different formations. Even within a single well, the TDS, as well as other water-quality metrics can fluctuate greatly, often necessitating robust and adaptable treatment processes to handle the variability in water quality. Such variations underscore the importance of continuous monitoring and tailored treatment strategies to enhance or optimize resource extraction and environmental management. But these ranges also fail to indicate the chemical treatments and other treatments one may expect in the midstream sites. Non-limiting examples of locations for midstream-liquid-resource sites include pipelines, which transport midstream-liquid resources from extraction sites to treatment facilities; disposal sites, designated for the safe disposal of wastewater through deep-well injection; midstream treatment plants, where contaminants such as hydrocarbons and dissolved salts are removed; midstream recycling plants, which treat midstream-liquid resources for reuse in oil & gas applications, and desalination plants, which remove high concentrations of dissolved salts to make the water suitable for reuse or discharge.

While formations have traditionally been characterized by their Total Dissolved Solids (TDS) values, other physical characterizations of midstream-liquid resources may also be crucial in developing effective pre-treatment regimens. Non-limiting examples of such characterizations include pH, which measures the acidity or alkalinity of the liquid and can influence the solubility of metals and the effectiveness of chemical treatments; turbidity, indicating the presence of suspended particles in the water and which can affect filtration and separation processes; oxidation-reduction potential (ORP), reflecting the liquid's ability to either gain or lose electrons, impacting the selection of oxidation or reduction treatments; iron content, which measures the concentration of dissolved iron that can precipitate and cause scaling; biochemical oxygen demand (BOD), which gauges the amount of oxygen required to break down organic matter, indicating the level of organic pollution; and sulfide concentration, which determines the presence of hydrogen sulfide, a toxic and corrosive compound requiring specific removal strategies. These examples are provided for illustrative purposes, and other measurements also may be employed to directly or indirectly develop and monitor pre-treatment regimens.

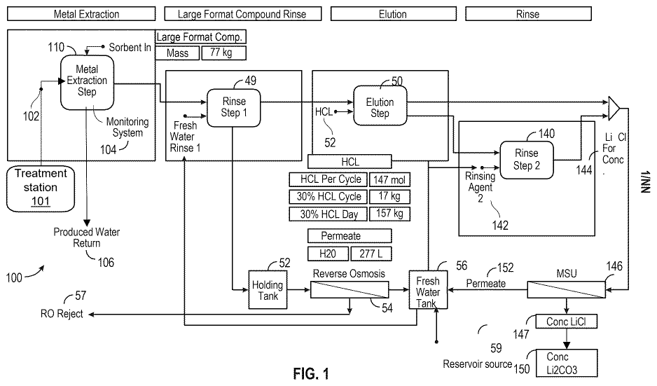

FIG. 1 is an exemplary system 100 configured to extract a desired metal from a volume of midstream-liquid resource, according to some embodiments of the present disclosure. For a discussion of direct-lithium-extraction systems, see Putro, Cahyo & Anderson, Corby, (2022), INVESTIGATION OF FACTORS AFFECTING DIRECT LITHIUM EXTRACTION WITH ION EXCHANGE, which is hereby incorporated by reference.

The system 100 depicts four phases that may be implemented to extract a metal from midstream-liquid resource, according to an embodiment.

The first step, the metal-extraction step 110, may include receiving midstream-liquid resource 102 into the system 100. Receiving the midstream-liquid resource 102 may include moving the midstream-liquid resource from a storage station (e.g., a pond or tank), a shipping container, or a well using a gravity feed, a pump system, or siphon mechanism to the batch or continuous processing system 100. Alternatively, in some embodiments, receiving the midstream-liquid resource 102 may include receiving the midstream-liquid resource from a transportation vehicle (e.g., a trailer, a tanker, or a rail car). In some embodiments, receiving the midstream liquid resource 102 may include receiving the midstream-liquid resource from a fixed assembly, such as a pipeline. In some embodiments, the midstream-liquid resource 102 is infused with nanobubbles, which can support the removal of oil, flocculants, hydrogen sulfide, solid iron precipitants, or the like present in the midstream-liquid resource.

Receiving a midstream-liquid resource 102 at a treatment station 101 involves several critical processes to enhance or to optimize the extraction of lithium and other valuable materials, according to an embodiment. At the treatment station 101, for example pipelines, tanks, or disposal sites, a treatment or treatment regimen may be applied to the midstream-liquid resource 102. For illustrative purposes, a treatment may refer to the application of a single chemical, mechanical, biological, or thermal treatment. In instances in which a treatment is applied multiple times, for example, based on a schedule of alternating volumes of midstream-liquid resource 102, or combining multiple treatment types, the terms “pre-treatment” and “treatment” regimens are used, according to an embodiment.

Receiving the midstream-liquid resource 102 at the treatment station 101 can involve several critical processes to enhance or to optimize the extraction of lithium and other valuable materials. At the treatment station 101, for example pipelines, tanks, or disposal sites, a treatment or treatment regimen may be applied to the midstream-liquid resource 102. For illustrative purposes, a treatment may refer to the application of a single chemical, mechanical, biological, or thermal treatment. In instances in which a treatment is applied multiple times, for example, based on a schedule of alternating volumes of midstream-liquid resource 102, or combining multiple treatment types, the terms “pre-treatment” and “treatment” regimens are used, according to an embodiment.

### Pre-Treatment

When the treatment station 101 is a pipeline, non-limiting examples of common pre-treatments and treatment regimens applied and chemicals present within the midstream-liquid resource 102 may include:

Biocides: Used to control microbial growth and prevent biofouling within the pipeline. Examples include oxidizers, glutaraldehyde, quaternary ammonium compounds (QUATs), DBNPA (2,2-Dibromo-3-nitrilopropionamide), and THPS (Tetrakis (hydroxymethyl) phosphonium sulfate).

Friction Reducers: Applied to reduce friction between the fluid and the pipeline walls, enhancing flow efficiency. Friction reducers are often added during hydraulic-fracturing operations or in the operations of midstream-water pipelines.

Corrosion Inhibitors: May be essential for protecting the metal surfaces of the pipeline from corrosion caused by the saline and acidic nature of produced water. Examples of corrosion inhibitors include amines, phosphate esters, and imidazolines.

Scale Inhibitors: Used to prevent the formation of mineral scales that can clog and damage the pipeline. Examples of scale inhibitors include phosphonates and polyacrylates.

When the treatment station 101 is a tank, non-limiting examples of common pre-treatments and treatment regimens may include:

Biocides: Similar to pipeline treatments, biocides are used to control microbial growth in storage tanks to prevent biofouling and maintain water quality during storage.

Demulsifiers: Applied to separate oil and water phases in the stored produced water. Demulsifiers can help in enhancing the separation efficiency before further treatment.

Paraffin Inhibitors: Used to prevent the deposition of paraffin waxes that can restrict fluid flow and reduce efficiency in storage tanks.

Hydrate Inhibitors: Applied to prevent the formation of gas hydrates, which can obstruct flow and damage equipment in storage conditions.

When the treatment station 101 (FIG. 1) is a disposal site, non-limiting examples of common pre-treatments and treatment regimens may include the following:

pH Adjusters: Used to maintain good or optimal pH levels, facilitating or ensuring the effectiveness of other chemical treatments and protecting equipment from corrosion and scaling.

Oxidizers: Applied to oxidize contaminants like hydrogen sulfide and organic matter, improving water quality and reducing odors. Non-limiting examples include but are not limited to hydrogen peroxide, ozone, bubbled oxygen, nanobubbled oxygen, aeration, chlorine, chlorine dioxide, sodium hypochlorite, peracetic acid, potassium permanganate, or calcium hypochlorite.

Coagulants and Flocculants: Used to aggregate suspended particles, making them easier to remove during filtration processes at disposal sites. Examples of coagulants and flocculants include polyaluminum chloride, aluminochlorohydrate, polyDADMAC, or starch-based flocculants.

Surfactants: Applied to reduce surface tension and improve the efficiency of separation processes, enhancing the removal of oils and organic matter.

When the treatment station 101 (FIG. 1) is a midstream recycling facility, non-limiting examples of common pre-treatments and treatment regimens may include the following:

Biocides: May be essential for maintaining water quality by controlling microbial growth during the recycling process.

Flocculants: Flocculants are commonly used to promote the aggregation of suspended particles in produced water and other wastewater midstream liquids, facilitating the separation of solids from liquids in various stages of the oil and gas production process. Non-limiting examples include Polyacrylamides (PAM), Polyethyleneimine (PEI), PolyDADMAC (Polydiallyldimethylammonium chloride), Polyamines, Chitosan, Starch-based flocculants, Ferric chloride, Aluminum sulfate (alum), Ferric sulfate, or Calcium hydroxide (lime).

Filtration Systems: Including media filtration, cartridge filters, bag filters, disc filters, membrane filtration, activated carbon, weir tank, settling tanks, dissolved-air flotation (DAF), or suspended-air flotation (SAF). These systems can be used to remove suspended solids, hydrocarbons, or other contaminants.

Desalination Processes: Used to concentrate the total dissolved solids (TDS) through membrane- or thermal-evaporation processes, making the water suitable for reuse.

Ion-Exchange Processes: Applied to alter the cationic or anionic constituency of the water, enhancing the removal of specific ions and improving water quality for reuse of the water.

When the treatment station 101 (FIG. 1) is a desalination plant, non-limiting examples of common pre-treatments and treatment regimens may include the following:

Pre-treatment Filtration: Using sand filters, media filters, or membrane filtration to remove suspended solids or other large particulates before desalination.

Scale and Corrosion Inhibitors: Used to protect the desalination equipment from scaling and corrosion caused by the high salinity of produced water.

Anti-foaming Agents: Applied to control foam formation during the desalination process, ensuring smooth operation and preventing overflow or damage to equipment.

Polishing Filtration: Used after desalination to further remove any remaining impurities, increasing the likelihood of, or ensuring, high-quality water output. This can include reverse osmosis and nanofiltration. Polishing can employ mechanical media (e.g., sand-bed filters, often referred to in the industry as deep-bed filtration, with media selected from natural materials, synthetic media, activated or unactivated glass), carbon media (e.g., granulated, powdered, extruded, impregnated, fiber, block, or catalytic activated carbon), chemical media (e.g., zeolite, manganese greensand, synthetic resin), or membrane elements (e.g., ultrafiltration, nanofiltration, reverse osmosis, or divalent-rejection membranes of polymeric or ceramic construction).

These treatments and regimens ensure the efficient and effective processing of produced water, generally improving water quality and protecting infrastructure throughout the oil and gas industry. In some embodiments the midstream-liquid resource comprises a turbidity of at least 100 Nephelometric Turbidity Units (NTU), a Total Suspended Solids (TSS) of at least 100 mg/L, and at least one of a negative Oxidation-Reduction Potential (ORP) up to +200 mV or an iron content greater than 5 mg/L. The pre-treatment of the received midstream liquid may minimize the quantity of TSS overall. In some embodiments, applying a treatment regimen may result in a pre-treated fluid with a turbidity of less than 20 Nephelometric Turbidity Units (NTU), Total Suspended Solids (TSS) of less than 200 mg/L, a positive Oxidation-Reduction Potential (ORP), or an iron content of less than 5 mg/L.

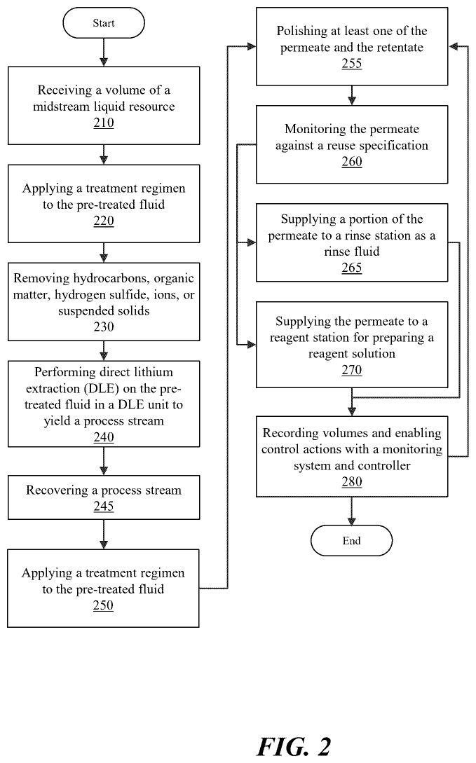

FIG. 2 is a flowchart that describes a method for enhancing or optimizing extraction of lithium from a midstream-liquid resource, according to some embodiments of the system 100 of FIG. 1 of the present disclosure.

In some embodiments, at 210, the method may include receiving a volume of a midstream-liquid resource (e.g., wastewater) from a pipeline, tank, or disposal site. Non-limiting examples of exemplary pre-treatments and locations where the pre-treatments may be applied are provided according to some embodiments of the present disclosure.

Still referring to FIG. 2, at 220, the method may include applying a treatment regimen to the pre-treated fluid. In some embodiments, the method of applying a treatment regimen to the pre-treated fluid at 220 involves multiple stages aimed at enhancing the quality and suitability of the midstream-liquid resource for further processing, particularly for lithium extraction at 240. Action 220 may involve removing contaminants and impurities that can affect the efficiency of the direct-lithium-extraction (DLE) process.

Applying a treatment to the pre-treated fluid at 220 may remove residual pre-treatment chemicals, their byproducts, or other remaining compounds in the midstream-liquid resource. This action may involve the removal of substances such as chelating agents, friction reducers, corrosion inhibitors, scale inhibitors, demulsifiers, paraffin inhibitors, hydrate inhibitors, pH adjusters, oxidizers, coagulants, flocculants, surfactants, and anti-foaming agents. In some embodiments, eliminating these chemicals and their byproducts prevents them from interfering with subsequent treatment stages and the direct-lithium-extraction process at 240.

Still referring to FIG. 2, at 240, a DLE unit selectively transfers lithium to generate process streams comprising (i) a lithium-depleted fluid in which lithium has been selectively removed from the pre-treated fluid and/or (ii) a lithium-concentrate fluid in which lithium is present in solution (for example, a rinse retained from a rinse step or a lithium product in solution formed at a reagent station), and/or (iii) a rinse. In some embodiments, the system 100 (FIG. 1) recovers a process stream selected from a lithium-depleted fluid, a rinse, or a lithium-concentrate fluid. In some embodiments, the DLE system 100 may generate multiple rinse-derived fluids during operation of a rinse 49 (FIG. 1) and associated rinse station. These rinse-derived fluids may include a retained rinse from the post-loading rinse operation, a first or second rinsing agent containing trace lithium or other solutes displaced from the sorbent composition, or combined rinse fractions that may mix with eluate effluent depending on valve positions or vessel-level conditions shown in FIG. 2. Some rinse-derived fluids may contain residual lithium, whereas others may be substantially free of lithium after displacement of midstream-liquid resources 102 (FIG. 1) or reagent 132 (FIG. 2) from the sorbent composition. As illustrated in FIG. 2, any such rinse-derived fluid may be directed, alone or in combination with lithium-depleted fluids or lithium-concentrate fluids, to the membrane-separation unit (MSU) at 146 for water removal or water concentration. As used herein, the membrane-separation unit at 146 (FIG. 1) is configured to remove at least a portion of the aqueous solvent from a recovered process stream. The membrane-separation unit may include, without limitation, reverse osmosis (RO), forward osmosis (FO), osmotically assisted reverse osmosis (OARO), nanofiltration (NF), polishing nanofiltration, or any other membrane-based separation configuration that produces a permeate stream (a membrane permeate) and a retentate stream (a membrane retentate). When the membrane-separation unit at 146 is referenced as performing membrane-based separation, the term encompasses any of these membrane-driven concentration or solvent-removal processes, regardless of whether the driving force is osmotic pressure, hydraulic pressure, or a combination thereof.

In certain modes, the controller (monitoring system) 104 may proportion rinse-derived fluids with other recovered process streams to enhance or to optimize TDS, conductivity, or ionic-strength conditions for downstream separation at membrane-separation unit 146. In some embodiments, a selectable routing connection allows a membrane-separation unit, such as the membrane separation unit 146, to be fed with either the lithium-depleted fluid or the lithium-concentrate fluid and to switch during operation. A bypass connection supplies qualified membrane permeate directly to the rinse station when the reuse specification is met. A process stream selected from the lithium-depleted fluid, a rinse or backwash fluid, and the lithium-concentrate fluid can be routed to downstream operations, such as a membrane station for water recovery and reuse within the DLE system. In some embodiments, at least a portion of the membrane permeate from the membrane station is used as a constituent of a backwash fluid applied to a filtration unit within the DLE system. Suitable filtration units include, without limitation, membrane modules, sand filters, multimedia filters, granular activated carbon units, prefilters, or other back-washable filtration systems. Using permeate as the aqueous base for backwash fluid can reduce fouling, minimize redeposition of solids, or support stable filtration performance. The presence of the foregoing compounds may impact, negatively, the efficiency of ion-exchange resins and lithium-selective membranes by causing fouling, scaling, or chemical degradation. Additionally, removing these substances may ensure compliance with environmental regulations and reduce or minimize potential harm to downstream ecosystems. This thorough purification may enhance the quality and consistency of the pre-treated fluid and the resulting process streams, enhancing or optimizing the conditions for lithium recovery at 240 and for downstream water-recovery and reuse.

In some embodiments, the treatment regimen 220 includes removal of undesirable constituents, non-limiting examples of which include hydrocarbons, organic matter, heavy metals, hydrogen sulfide, nitrogen-containing compounds such as ammonia, pre-treatment chemicals, or pre-treatment chemical by-products. While these examples are provided in a list, not all constituents will be present at every point within a midstream system. In some embodiments, removal of undesirable constituents is achieved through a combination or subcombination of chemical oxidation, biological treatment, and activated-carbon filtration.

In some embodiments, the treatment regimen 220 removes one or more of hydrocarbons, organic matter, heavy metals, hydrogen sulfide, pre-treatment chemicals, or pre-treatment chemical by-products using a combination or sub-combination of chemical oxidation, biological treatment, and activated-carbon filtration.

Following removal of organic contaminants and hydrocarbons, eliminating ions and suspended solids may be desirable within treatment regimen 220. Flocculation and coagulation can introduce chemical coagulants (e.g., alum, ferric chloride) and flocculants (e.g., polyacrylamide, polyDADMAC) to aggregate suspended particles into larger flocs for removal. Filtration techniques, including media filtration with sand, anthracite, or other granular media, may capture suspended solids. Membrane-filtration techniques such as microfiltration, ultrafiltration, and nanofiltration can remove fine particulates and dissolved substances, including ions. Dissolved-air flotation (DAF) and suspended-air flotation (SAF) can inject air bubbles that attach to suspended particles and lift them for skimming within treatment regimen 220.

To control microbial growth and reduce biofouling in subsequent processing stages, biocides may be applied. Oxidizers can act as biocides; additional biocides such as glutaraldehyde and quaternary ammonium compounds (QUATs) may be used. DBNPA and THPS are sometimes selected for their effectiveness in killing bacteria and assisting with removing iron and other metals.

Adjustments to the chemical composition of the pre-treated fluid may be used to enhance conditions for direct lithium extraction at 240. For example, pH adjusters like lime or sodium hydroxide can set target pH windows for downstream operations. In some embodiments, ion-exchange processes utilizing resins or media (e.g., zeolite, synthetic resins) are used to selectively remove ions that may interfere with downstream uses.

A final pretreatment polishing step can be implemented as part of the treatment regimen 220 and/or action 230 to satisfy a DLE-feed specification. High-efficiency polishing filters, media beds, cartridge filters, and disc filters may remove remaining particulates down to approximately one micron. Membrane polishing (e.g., microfiltration, ultrafiltration, nanofiltration) can reduce further turbidity and residual organics or divalents to protect the DLE unit. In some embodiments, membrane polishing is used as a pretreatment operation distinct from the osmosis station described for post-DLE water recovery and reuse (actions 250-280). Where a further concentration of lithium is desired in the concentrated-lithium product, in some embodiments, concentration is performed on the recovered 245 portion of the process stream containing the lithium-concentrate fluid recovered after DLE. Concentration may commence as a subaction of performing direct lithium extraction (DLE) on the pre-treated fluid in a DLE unit to yield a process stream 240, and may be routed and further concentrated according to 250-280.

This treatment regimen can mitigate challenges introduced by upstream chemicals and variable water quality. By removing contaminants that interfere with direct lithium extraction at 240, the efficiency and yield of DLE can be enhanced. The removal of corrosive substances, scaling agents, and biofouling organisms may prolong the lifespan or operational reliability of the DLE equipment. In some embodiments, the treatment processes 230 may also facilitate environmental compliance for any discharge streams.

At 230, the method may include removing hydrocarbons, organic matter, hydrogen sulfide, ions, or suspended solids. The regimen 230 may include oxidizers, flocculants, coagulants, or surfactants to improve phase separation or solids capture.

In some embodiments, oxidizers such as hydrogen peroxide, ozone, bubbled oxygen, nanobubbled oxygen, carbon dioxide, aeration, chlorine, chlorine dioxide, sodium hypochlorite, peracetic acid, potassium permanganate, or calcium hypochlorite may be applied. Flocculants (e.g., polyacrylamide, polyethyleneimine, polyDADMAC, starch-based flocculants, chitosan) can aggregate fine particles for removal.

Coagulants such as polyaluminum chloride, aluminochlorohydrate, Polyaluminum Chloride (PAC), Aluminum Sulfate (Alum), Ferric Chloride, Ferric Sulfate, Ferrous Sulfate, Sodium Aluminate, or Calcium Hydroxide (Lime) may destabilize suspended particles. Surfactants (e.g., PEGs, alcohol ethoxylates, LAEs, SDS, SLS, OPEOs, NPEOs, APGs, cocamidopropyl betaine, saponins, glycolipids, or rhamnolipids) may be used to adjust interfacial behavior and improve oil-water separation.

The treatment regimen 230 may occur using equipment such as DAF units, SAF units, media-filtration systems, cartridge filters, bag filters, disc filters, membrane-filtration systems, activated-carbon units, or weir tanks. DAF and SAF can remove suspended solids and oils; media and membrane filtration can capture finer particles and dissolved contaminants.

In some embodiments, the treatment regimen 230 splits the midstream-liquid resource into a retentate (concentrating impurities such as hydrocarbons, organic matter, or suspended solids) and a filtrate that serves as the treated feed to the direct-lithium-extraction operation at 240. Performing DLE on the filtrate in a DLE unit (e.g., ion-exchange/adsorption with a sorbent composition, membrane-based separation, or electrochemical extraction) can yield a process stream comprising at least one of: a lithium-depleted fluid in which lithium has been selectively removed from the pre-treated fluid, a rinse, or a lithium-concentrate fluid in which lithium is present in solution as a result of the DLE operation, for example, a retained rinse produced during a rinse step and/or a lithium product in solution generated at a reagent station during desorption/elution. The DLE unit may receive pre-treated feeds sourced from, for instance, a desalination plant side-stream, a geothermal brine loop, or oil-and-gas produced-water infrastructure; in each case, DLE produces the foregoing process streams with lithium either depleted from, or concentrated within, the aqueous phase. Either of these process streams can be recovered as the process stream of step 250 for routing to an osmosis station, thereby maintaining continuity with the reuse loop described herein. The osmosis station can be equipped with membranes in tubular, spiral-wound, flat-sheet, or osmotically assisted formats.

In some embodiments, applying a treatment regimen to the pre-treated fluid includes one or more of steps 210-220. Removing hydrocarbons, organic matter, ions, or suspended solids can include applying at least one of polyacrylamide (PAM), polyethyleneimine, polyamines, polyDADMAC, starch-based flocculants, chitosan, or another organic or inorganic flocculant.

The treatment regimen at 230 may include additional steps using DAF, SAF, media filtration, cartridge filters, bag filters, disc filters, membrane filtration, activated carbon, or weir tanks to address residual contaminants.

For example, oxidizers such as hydrogen peroxide, ozone, or chlorine dioxide may be applied to break down organics and reduce biological load. Flocculants such as polyacrylamide and chitosan may aggregate fine particles. Coagulants such as polyaluminum chloride and ferric chloride may destabilize suspended particles. Surfactants such as SDS or nonylphenol ethoxylates may improve oil-water separation.

The regimen at 230 also may involve splitting the midstream-liquid resource into a retentate and a filtrate via membrane filtration, traditional filtration (e.g., sand-bed, media, or cartridge filtration), centrifugation, or weir-tank settling. The retentate (e.g., sludge, concentrated brine) may be disposed of or further treated; the filtrate is further purified and passed to 240 for lithium recovery. In some embodiments, the midstream-liquid resource is a process stream. The process stream comprises at least one of (i) a lithium-depleted fluid in which lithium has been selectively removed from the pre-treated fluid, (ii) a lithium-concentrate fluid in which lithium is present in solution as a result of the DLE operation (for example, a rinse retained after a rinse step and/or a lithium product in solution produced at a reagent station), and (iii) a rinse (e.g., a post-loading (PL) rinse).

At 240, the method includes performing direct lithium extraction (DLE) on the pre-treated fluid in a DLE unit to yield a process stream. The process stream comprises at least one of: (i) a lithium-depleted fluid in which lithium has been selectively removed from the pre-treated fluid, (ii) a lithium-concentrate fluid in which lithium is present in solution as a result of the DLE operation (for example, a rinse retained after a rinse step and/or a lithium product in solution produced at a reagent station), and (iii) a rinse (e.g., a post-loading (PL) rinse). The DLE operation may include ion exchange or adsorption using a sorbent composition, membrane-based separation, electrochemical extraction, or combinations thereof. Conditioning at 220-230 can reduce foulants and stabilize chemistry to improve DLE performance and the quality of the resulting process stream, which is subsequently handled per steps 250-280 for water recovery and reuse.

At 240, the method includes performing direct lithium extraction (DLE) on the pre-treated fluid in a DLE unit to yield a process stream. The process stream comprises at least one of: (i) a lithium-depleted fluid in which lithium has been selectively removed from the pre-treated fluid, (ii) a lithium-concentrate fluid in which lithium is present in solution as a result of the DLE operation (for example, a retained rinse and/or a lithium product in solution produced at a reagent station), or (iii) a rinse, such as a post-loading (PL) rinse generated during displacement of midstream-liquid resources or reagent from the sorbent composition during the rinse step. The DLE operation may include ion exchange or adsorption using a sorbent composition, membrane-based separation, electrochemical extraction, or combinations thereof. Conditioning at 220-230 can reduce foulants and stabilize chemistry to improve DLE performance and the quality of the resulting process stream.

Following step 240, the DLE unit yields and recovers a process stream 245. For exemplary purposes, the process stream may include (i) a lithium-depleted fluid in which lithium has been selectively removed from a midstream resource by the DLE process, (ii) a lithium-concentrate fluid in which lithium is concentrated in solution, and/or (iii) a rinse such as a post-loading (PL) rinse generated during the rinse step. In sorbent or ion-exchange embodiments, the lithium-concentrate fluid may comprise a retained rinse and/or a lithium product in solution formed at a reagent station at 245. In membrane-based embodiments, the lithium-concentrate fluid may comprise an aqueous liquid generated by the membrane-based separation. In electrochemical embodiments, the lithium-concentrate fluid may comprise a product solution downstream of the electrochemical extractor. The selected process stream 245 is routed via piping and automated valves to a membrane-separation unit.

At the membrane-separation unit, the selected process stream 245 is subjected to membrane filtration 250 to produce a permeate and retentate. The membrane-separation unit may be configured for forward osmosis (FO), reverse osmosis (RO), or osmotically assisted operation, using membranes of polymeric or ceramic construction in tubular, flat-sheet, spiral-wound, hollow-fiber, or disc-tube formats. In some embodiments, the membrane-separation unit may employ other membrane-based concentration or filtration techniques, including nanofiltration (NF), ultrafiltration (UF), microfiltration (MF), polishing nanofiltration, or other membrane configurations suitable for removing at least a portion of the aqueous solvent or conditioning the process stream prior to downstream processing. In some embodiments in which the feed is a lithium-concentrate fluid, the feed pH at the membrane-separation unit is 3.5 or below. The permeate 250 is collected in a first vessel and the retentate is collected in a second vessel. In some embodiments, level instrumentation on the vessels provides volumetric inventory for subsequent reuse or handling. In embodiments wherein the recovered process stream is a lithium-concentrate fluid (e.g., LiCl, Li₂SO₄, or a reagent-station product in solution), the feed pH is at or below 3.5 when introduced to the membrane-separation unit; in some cases, the pH is adjusted down to 3.5 or below prior to membrane-separation.

For illustrative purposes, the recovered process stream 245 is subjected to a treatment regimen (e.g., forward osmosis (FO) 250 to produce a permeate and retentate. The forward-osmosis station drives water transport from the recovered process stream across a semi-permeable membrane into a draw solution having higher osmotic pressure. The draw solution is subsequently conditioned (e.g., via reverse osmosis (RO) or thermal separation) to recover a permeate suitable for reuse and to regenerate the draw. FO can be advantageous for high-TDS or low-pH lithium-concentrate fluids where a hydraulic pressure operation is undesirable.

For illustrative purposes, the recovered process stream at 245 is subjected to a treatment regimen (e.g., RO) 250 to produce a permeate and a retentate. The treatment (e.g., reverse-osmosis) station applies hydraulic pressure to the recovered process stream across a semi-permeable membrane to generate the permeate and retentate. Where the treatment regimen is RO, RO modules may include nanofiltration or divalent-rejection elements upstream or integrated to improve flux or scaling control. The retentate can be directed to further concentration, recycle, or disposal as dictated by site practice.

In some embodiments, at least one of the permeate and the retentate is polished at 255 to meet a reuse or discharge window. Polishing at 255 may employ a mechanical-polishing technique (e.g., a sand-bed filter or carbon filter with media selected from granulated activated carbon, powdered activated carbon, extruded activated carbon, impregnated activated carbon, activated-carbon fibers, biochar, carbon-block, or catalytic activated carbon), a chemical-polishing technique (e.g., ion-exchange media selected from zeolite, manganese greensand, or synthetic resin), a membrane filter (e.g., ultrafiltration, nanofiltration, reverse-osmosis, or divalent-rejection membranes), and/or a biological polishing technique. The polishing unit may be inline with the permeate outlet or implemented as a side-stream loop from the first vessel. Alternatively, or in addition to polishing, the permeate or retentate can be directed to a holding tank for further processing (e.g., crystallizing, evaporating, or selling to a third party) or for compliant disposal in some embodiments.

In some embodiments, at 260 a system monitors the permeate quality against a reuse specification including at least Total Dissolved Solids (TDS) and pH. Inline or at-line sensors (e.g., conductivity-based TDS, pH probes) communicate with a monitoring system. When the reuse specification at 260 is not satisfied, control logic gates reintroduction and diverts the stream to some remediation action, such as further polishing, recycling, or disposal (e.g., removal from the DLE system). When the reuse specification at 260 is satisfied, the controller enables reuse of the polished stream by opening valves that route the permeate or retentate to one or more supply connections 265 within the DLE system.

In some embodiments, monitoring at a point of reintroduction comprises measuring at least TDS and pH of the permeate or retentate immediately upstream of a supply connection and enabling reintroduction only when a reuse specification is satisfied, the reuse specification including at least a TDS bound and a pH bound. When not satisfied, the controller directs the permeate or retentate to a polishing unit or a holding vessel until the specification is met. The monitoring system is further configured to acquire online TDS and pH at an outlet of the membrane-separation station and at each point of reintroduction and to gate valve actuation such that the supply of permeate or retentate to the reuse station occurs only when a reuse specification comprising at least a TDS bound and a pH bound is satisfied.

In some embodiments, a first supply connection hydraulically couples the first vessel (or permeate header) to a rinse station at 265. Control valves and a ratio controller allow the permeate to constitute at least a portion of a rinse fluid. In some embodiments, the controller blends permeate with water from a fresh-water tank and/or other reagent to a specified setpoint (e.g., TDS or pH), then delivers the blend as the rinse fluid applied by the rinse station before desorption or after a contact time elapses.

A second supply connection hydraulically couples the first vessel (or permeate header) to a reagent station that prepares a reagent solution at 270. In some embodiments, the reagent comprises an acid selected from HCl and H₂SO₄, and the osmosis permeate provides some or all of the solvent for make-up to a target normality. The monitoring system can verify that the permeate meets a reagent-grade window (e.g., pH and TDS bounds) before enabling transfer.

A monitoring system and controller (e.g., PLC/SCADA) receives signals from flow meters on the first and second supply connections, level transmitters on the first and second vessels, and quality sensors (TDS, pH) at 280. In some embodiments, the controller allocates permeate between the first supply connection and the second supply connection according to the reuse specification (TDS/pH), and, when available, blends permeate with fresh water to meet target rinse or reagent make-up windows. In some embodiments, the controller allocates permeate between the first and second supply connections based on the reuse specification and reduces the fresh-water-tank flowrate in proportion to increased permeate availability. The controller (i) records volumes of permeate produced, polished, and reintroduced; (ii) computes reuse fractions and water-savings metrics; and (iii) commands valves/pumps to enable or disable supply based on the reuse specification and station demand. Event logs and historian records may be exported for compliance or performance tracking.

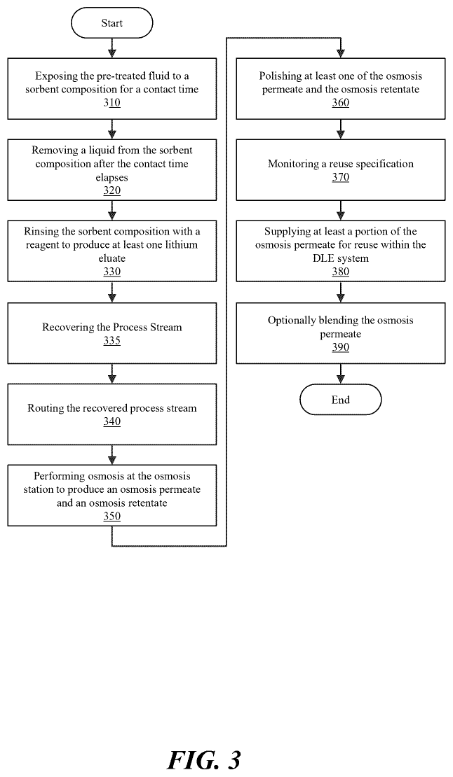

FIG. 3 is a flowchart that describes a method, according to some embodiments of the present disclosure. In some embodiments, at 310, the method may include exposing a pre-treated fluid to a sorbent composition for a contact time.

At 320, the method may include removing a liquid from the sorbent composition after the contact time elapses.

At 330, the method may include rinsing the sorbent composition with a reagent to produce at least one lithium eluate. Performing critical material extraction further comprises steps 310 to 330.

In some embodiments, the sorbent composition may be one or more of a lithium manganese oxide (LMO), a lithium manganese oxide (LMO)-type lithium ion-sieve (LIS), a titanate sorbent, or an aluminate sorbent. Rinsing the sorbent composition further comprises concentrating an initial lithium concentration of the at least one lithium eluate to a lithium cycle concentration between 100-500 ppm per cycle, thereby forming a lithium product in solution. In some embodiments in which the lithium product is a lithium carbonate product, a post-elution rinse is performed followed by concentrating the initial lithium concentration to a lithium cycle concentration between 3,000-25,000 ppm per cycle, thereby forming the lithium product.

At 310, the method may include exposing the pre-treated fluid to a sorbent composition for a specified contact time. In some embodiments, the pre-treated fluid, having undergone initial treatments to remove hydrocarbons, organic matter, hydrogen sulfide, ions, or suspended solids, is now prepared for critical-material extraction. The sorbent composition used in this step may be selected based on its affinity for lithium and may include one or more of lithium manganese oxide (LMO), lithium manganese oxide (LMO)-type lithium ion-sieve (LIS), titanate sorbent, or aluminate sorbent. The contact time can be essential to ensure that lithium ions in the pre-treated fluid are effectively captured by the sorbent composition. The duration of the contact time may vary depending on factors such as the concentration of lithium in the fluid, the type and capacity of the sorbent used, or the desired efficiency of the extraction process. The elution operation may generate a lithium-concentrate fluid.

At 320, the method may include removing the liquid from the sorbent composition after the contact time elapses. This removing involves separating the now lithium-enriched sorbent from the remaining fluid. The separation process may employ various techniques such as filtration, centrifugation, or decantation, or reactor-based separation (e.g., draining, displacing, or settling within a contactor or reactor vessel), ensuring that the sorbent, now containing the absorbed lithium ions, is efficiently isolated from the residual liquid. The removed liquid, which is now depleted of a significant portion of its lithium content, may undergo further processing or disposal depending on its composition and any remaining contaminants.

At 330, the method may include rinsing the sorbent composition with a reagent to produce at least one lithium eluate. This rinsing can be crucial for recovering lithium from the sorbent. The rinsing process involves applying a reagent, which may be an acidic or basic solution, including acid or water, to desorb or exchange the lithium ions from the lithium-laden sorbent. The reagent serves to desorb the lithium ions from the sorbent, effectively transferring them into a solution known as the lithium eluate. In some embodiments, the reagent composition and the rinsing conditions are carefully controlled to increase or to maximize the concentration of lithium in the eluate. For illustrative purposes, in some embodiments the system may be modified to work with different types of sorbents. In some embodiments, the sorbent may be an aluminate sorbent, wherein the rinsing process involves applying a reagent such as fresh water, to desorb or exchange the lithium ions from the lithium-laden sorbent. In other embodiments, the sorbent may be an ion-exchange material such as a titanium-based, manganese-based, or polymer-based ion-exchange material. When using an ion-exchange material, the rinsing process involves applying a reagent, which may be an acidic or basic solution, including acid, to desorb or exchange the lithium ions from the lithium-laden sorbent. In either embodiment, the reagent serves to desorb the lithium ions from the sorbent, effectively transferring them into a solution known as the lithium eluate. In some embodiments, the reagent composition and the rinsing conditions are carefully controlled to increase or maximize the concentration of lithium in the eluate (e.g., reduce or minimize dilution by increasing or maximizing desorbing the lithium ions from the sorbent). For an aluminate sorbent, it may be desirable to use a higher pH solution or modify the contact time to increase the likelihood of or ensure efficient lithium desorption, given the sorbent's affinity for lithium under certain chemical conditions. These illustrative adjustments help maintain the efficacy of the process and increase the likelihood of, or ensure, a high recovery rate of lithium from the sorbent.

Estimating the concentration of lithium in the eluate during direct lithium extraction (DLE) can be challenging due to several influencing factors. When rinsing the sorbent composition with a reagent to produce a lithium eluate at 330, the concentration of lithium in the resulting solution is subject to variability introduced by numerous variables. These variables include:

Initial PPM of Pre-Treated Fluid: The concentration of lithium in the pre-treated fluid can be a key starting point. Higher initial lithium concentrations generally yield higher eluate concentrations, assuming consistent processing conditions.

Absorption Capacity of the Sorbent Composition: The sorbent's ability to hold lithium ions affects how much lithium can be extracted and ultimately desorbed into the eluate. Sorbents with higher capacity typically will result in a higher concentration of lithium in the eluate.

Volume of the Sorbent Composition: The total volume of sorbent available for lithium absorption can influence the overall effectiveness of the extraction process. Larger sorbent volumes can handle greater amounts of pre-treated fluid, potentially leading to higher lithium recovery, but the eluate concentration may vary depending on the distribution of lithium across the sorbent material.

Contact Time at 310: The duration of exposure between the pre-treated fluid and the sorbent can impact how much lithium is absorbed. Insufficient contact time may lead to lower lithium absorption and thus lower eluate concentrations, while extended contact time can enhance lithium uptake but may also introduce diminishing returns.

Volume of the Rinsing Agent at 330: The amount of rinsing agent used to desorb lithium from the sorbent can affect, directly, the final concentration of lithium in the eluate. Larger volumes of rinsing agent can dilute the lithium concentration, while smaller volumes can lead to a more concentrated eluate, albeit with the risk of incomplete desorption.

Effectiveness of the Rinsing Agent 330: The chemical composition and strength of the rinsing agent can play a significant role in determining how much lithium is effectively desorbed from the sorbent. Stronger acids or enhanced or optimized reagents may yield higher lithium concentrations by more effectively releasing the absorbed ions, whereas weaker or less-effective rinsing agents may result in lower lithium concentrations.

These variables interact in complex ways that influence lithium concentration in the eluate. Nonetheless, for illustrative purposes, the process of concentrating the eluate may be repeated across one or more cycles to concentrate the lithium eluate to a desired level by performing reverse osmosis. A non-limiting example of a concentrating treatment may concentrate the lithium ppm from between 100 and 500 ppm per cycle, thereby forming a lithium product in solution that is ready for further purification or use. In some embodiments, it may be desirable to concentrate the lithium product ppm to a concentration of approximately 10,000 ppm by repeating one or more cycles to concentrate the lithium eluate.

After the rinsing at 330, in some embodiments the method includes recovering a process stream at 335. The process stream comprises at least one of: (i) a lithium-depleted fluid in which lithium has been selectively removed from the pre-treated fluid during the contact time with the sorbent, (ii) a lithium-concentrate fluid in which lithium is present in solution as a result of the direct-lithium-extraction operation, for example a rinse retained after the rinsing step and/or a lithium product in solution produced at a reagent station, or (iii) a rinse, such as a post-loading (PL) rinse generated during displacement of midstream-liquid resources or reagent from the sorbent during the rinsing step. In ion-exchange/adsorption embodiments, the lithium-depleted fluid may be the liquid removed from the sorbent bed after the contact time, while the lithium-concentrate fluid may be the retained rinse and/or the eluate produced when a reagent (e.g., HCl or H₂SO₄) desorbs lithium from the sorbent. In membrane-based or electrochemical DLE embodiments, the lithium-concentrate fluid may be the aqueous concentrate generated by the membrane or produced downstream of the electrochemical cell, respectively.

At 340, the recovered process stream is routed, e.g., to a membrane-separation unit. In some embodiments, at 350, osmosis is performed. Osmosis, such as reverse osmosis or forward osmosis, is performed at 350 to produce an osmosis permeate and an osmosis retentate. The osmosis permeate is collected in a first vessel and the osmosis retentate is collected in a second vessel to enable separate handling, storage, or downstream processing. In some embodiments, when the process stream is a lithium-concentrate fluid (e.g., LiCl or Li₂SO₄ solution, optionally at a feed pH of 3.5 or below), membrane separation removes water to increase lithium concentration in the retentate while simultaneously generating a low-TDS permeate for reuse.

At 360, at least one of the permeate and the retentate is optionally polished. Mechanical polishing can include, for example, a sand-bed filter (media selected from natural, synthetic, activated glass, or unactivated glass) and/or a carbon filter (media selected from granulated activated carbon, powdered activated carbon, extruded activated carbon, impregnated activated carbon, activated-carbon fibers, biochar, carbon-block, or catalytic activated carbon). Chemical polishing can include ion-exchange media such as zeolite, manganese greensand, or synthetic resin. In other embodiments, polishing includes a membrane filter such as ultrafiltration, nanofiltration, reverse osmosis, or a divalent-rejection membrane constructed from polymeric or ceramic materials.

At 370, the method monitors a reuse specification, including, for example, at least Total Dissolved Solids (TDS) and pH, at a point of reintroduction within the DLE system. Reuse of the permeate or retentate is enabled only when the reuse specification is satisfied; otherwise, the permeate or retentate can be directed to additional polishing or can be held in the first vessel until the specification is met.

At 380, at least a portion of the permeate or retentate is reintroduced, or otherwise supplied, for reuse within the DLE system. In some embodiments, the permeate is supplied to a rinse station as at least a portion of a rinse fluid applied to the sorbent composition. In other embodiments, the permeate is supplied to a reagent station for preparing a reagent solution (e.g., hydrochloric acid or sulfuric acid) used to elute lithium from the sorbent composition. In additional embodiments, the permeate is used as a constituent of other fluids or streams within the DLE system 100. For example, at least a portion of the permeate may be used as a constituent of a cleaning fluid applied during membrane-cleaning operations, as a constituent of a backwash fluid applied to filtration units (e.g., sand-bed, multimedia, or carbon filters), or as a constituent of an electrolysis-makeup fluid supplied to an electrochemical unit. In other embodiments, permeate is used as a constituent of general DLE system makeup fluid to maintain hydraulic balance or ionic strength within the system, or is blended with other aqueous streams to condition TDS, pH, or conductivity prior to downstream processing. In further embodiments, at least a portion of the retentate is reintroduced for reuse, including reuse for alkalinity adjustment, retaining lithium that would otherwise be lost to disposal, balancing ionic strength, blending with a feed stream, or supporting internal recirculation loops that improve separation efficiency.

At 390, the permeate may be blended with fresh water in a vessel to meet a specified conductivity, TDS, or pH prior to reintroduction, and a controller records volumes and allocates flow between (i) the rinse station and (ii) the reagent station. In some embodiments, the controller decreases a flowrate from a fresh-water tank in proportion to an increase in permeate flow, thereby reducing fresh-water draw while maintaining process setpoints at the point of use.

Returning to FIG. 1, removing oil and other chemicals may increase the period during which a sorbent composition, such as a spinel, can directly extract a desired metal in the metal extraction 110. The system 100 may be configured to process a volume of a midstream-liquid resource measured in various volumes and may accommodate a variety of concentrations of one or more metals. Accommodating a variety of concentrations of metals may be necessary when extracting metal from a midstream-liquid resource, as the concentrations of metals can fluctuate, sometimes predictably, over the life of a well. In some embodiments, the system may pre-process or otherwise pretreat the midstream-liquid resource 102 prior to the metal-extraction 110. While a midstream-liquid resource has been provided as one non-limiting example, the aforementioned principles are applicable to subsurface brines and liquid resources. In some embodiments of the continuous processing system 100, the liquid resource may be a natural brine, a dissolved salt flat, seawater, concentrated seawater, a desalination effluent, a concentrated brine, a processed brine, an oilfield brine, a liquid from an ion-exchange process, a liquid from a solvent-extraction process, a synthetic brine, a leachate from an ore or combination of ores, a leachate from a mineral or combination of minerals, a leachate from a clay or combination of clays, a leachate from recycled products, a leachate from recycled materials, or combinations or subcombinations thereof.

In some embodiments, the metal-extraction 110 is aided by the use of a sorbent composition capable of extracting metals, for example metals in ionic form within the midstream-liquid resource. In some embodiments, a sorbent composition, for example an LMO sorbent greater than 100 microns, may be scaled up to accommodate volumes of produced wastewater over 10,000 barrels. While the present example details the use of a sorbent composition and sorbent composition, smaller format sorbents, doped sorbents, undoped sorbents, coated sorbents, uncoated sorbents, or combinations or subcombinations thereof may be used to adsorb a desired metal from the metal-containing fluid. Sorbent compositions may process more than 33,122 liters per contact with a thirty-minute contact time. Contact time may be varied depending upon the amount of desired metal to be extracted. The amount of desired metal may be arrived at using various methods, for example by the desired mass of recovered metal or as measured in the reduction of the concentration of the desired metal from the metal-containing fluid (e.g., a brine). Contact time also may be influenced by the extraction technology used. Fluids produced during these operations can constitute lithium-concentrate fluids, including a rinse retained after rinse one 49 and a lithium product in solution formed at the reagent station during elution. In some embodiments, the rinse one 49 produces one or more rinse-derived fluids suitable for further processing within the DLE system 100. Such rinse-derived fluids may include a retained rinse from the post-loading rinse operation, a primary or secondary rinsing agent containing trace amounts of lithium or other solutes released from the sorbent composition, or combined rinse fractions resulting from sequential rinsing or mixing with eluate effluent. Depending on sorbent behavior and process conditions, these rinse-derived fluids may contain residual lithium, may be substantially free of lithium, or may contain intermediate concentrations. The DLE system 100 may route any such rinse-derived fluid to the membrane-separation unit (MSU) 146 for water removal (e.g., by osmosis) or membrane-based separation, alone or in combination with other aqueous streams.

The metal extraction 110 may use technology alternatives outside of format compositions (e.g., LMO sorbents) such as Electrochemical Extraction, Ionic Liquid Extraction, Membrane Technologies, Solvent Extraction, or Precipitation and Crystallization, where the use of nanobubbles in these systems may aid the metal-extraction process. While several technologies have been discussed, different types of metal-producing waters and metals sought for extraction may necessitate the use of one or more of the aforementioned technologies. The system 100 may use batch-processing or continuous-processing techniques to run as many as 48 (forty eight) contacts prior to exhausting the sorbent composition. In some embodiments, the contact time may be tuned to account for the initial concentration of metal within the midstream-liquid resource 102 to ensure sufficient contact with the sorbent composition, e.g., an ion-exchange media, to remove the desired volume (or other units such as mass) of metal from the midstream-liquid resource. To perform the metal extraction 110, the system 100 may be configured with a monitoring system 104 to monitor the change of metal concentration. The monitoring system 104 may be equipped with a CPU, peripheral devices such as a temperature sensor, a pH sensor, or other chemical-properties-and-contents sensors that may be used to characterize the contents and nature of the midstream-liquid resource. In some embodiments, the monitoring system 104 may monitor the duration of the contact time, the contact time, the volume of midstream-liquid resource in the system, the count of elapsed contact times, the status of equipment (e.g., the health of equipment, a maintenance status, or the active or inactive status of equipment), and visual and/or audible indicators to alert a user to act. The CPU may be connected to the internet or a local network to send status updates of the system. For example, as a sorbent composition, for example, a sorbent, approaches the end of its useful life, the CPU of the digital monitoring system may create an alert and transmit the alert to a user interface so the sorbent may be replenished at an appropriate time.

In some embodiments, the midstream-liquid resource is removed 106 during or after the metal extraction 110. In some embodiments, the midstream-liquid resource may be actively removed using an appropriate mechanism that sequesters the sorbent composition from the midstream-liquid resource. The midstream-liquid resource 106 may also be further processed to extract additional metals in a staged continuous-extraction process. In an alternative embodiment, the midstream-liquid resource may be transferred to another portion of the system 100 adapted to extract a second metal, pollutant, or to administer a treatment prior to returning the midstream-liquid resource for transport to an alternative site. In some embodiments, a process stream is routed to a membrane-separation unit 146 for water removal, yielding a permeate and a retentate that can be reused in the system. As used herein, the membrane-filtration station 146 refers to a membrane-separation unit configured to remove at least a portion of the aqueous solvent from a recovered process stream. The membrane-separation unit 146 may include, without limitation, reverse osmosis (RO), forward osmosis (FO), osmotically assisted reverse osmosis (OARO), nanofiltration (NF), polishing nanofiltration, or any membrane-based separation feature, structure, or system that produces a permeate stream and a retentate stream. As used herein, a “membrane permeate” or “membrane retentate” includes the permeate and retentate streams produced by a membrane station, including streams produced by RO, FO, NF, polishing membranes, or any membrane-separation configuration deployed within the DLE system 100.

In some embodiments, a recovered process stream is routed to the membrane-separation unit 146 for water removal or water concentration. The recovered process stream may include, for example, a retained rinse from the rinse one 49, a lithium-bearing eluate 144 produced by the reagent/elution 50, or a lithium product in solution produced downstream of the elution step. In some embodiments, a rinse recovered from the rinse one 49 may contain little or no lithium, for example when the rinse serves primarily to displace midstream-liquid resources or reagent 52 (e.g., hydrochloric acid (HCl)) from the sorbent composition. Such rinses, even when substantially lithium-free, may nonetheless be routed to the membrane-separation unit 146 as part of one or more of the recovered process streams described herein, and still remain within the scope of a “rinse” as recited herein. At the membrane-separation unit 146, the recovered process stream undergoes a water-removal or water-concentration step in which at least a portion of the aqueous solvent is removed by an osmosis process, such as reverse osmosis, forward osmosis, or nanofiltration operated in an osmotically driven mode. The membrane-separation unit 146 generates a permeate and retentate. The permeate possesses reduced levels of dissolved solids relative to the recovered process stream and can serve as an internally generated source of clean aqueous fluid for reuse within the DLE system 100. The retentate constitutes or contains a lithium brine concentrate with elevated concentrations of lithium and other solutes that may be further processed, reused within the DLE system 100, or directed to downstream concentration and finishing equipment. In regions where access to fresh water is limited, where municipal water infrastructure is unavailable, or where transporting clean water to remote sites is prohibitively expensive, generating permeate on-site and reusing both permeate and retentate streams offers substantial operational, economic, and environmental advantages.

In some embodiments, at least a portion of the permeate is reintroduced for reuse within the DLE system 100 as a constituent of one or more process fluids. Because the permeate has substantially lower dissolved-solids content than the recovered process stream, the permeate provides a stable, predictable aqueous base that can be used neat or blended with external fresh water to meet a desired reuse specification. Reintroducing at least a portion of the permeate in this manner can reduce demand on external fresh-water supplies, simplify water-logistics planning in remote deployments, or allow the DLE system 100 to internally balance its water inventories.

In one embodiment, the permeate is reused as a constituent of a rinse fluid supplied to the rinse one 49. Rinse operations typically require a low-TDS, low-fouling aqueous stream to displace residual midstream-liquid resources and reagents from sorbents, ion-exchange materials, or vessel surfaces without depositing additional solids. Using at least a portion of the permeate as a constituent of the rinse fluid enables predictable rinsing behavior and reduces the risk of introducing contaminants that could interfere with subsequent metal-extraction, elution, membrane-based steps, or that otherwise could reduce the purity of intermediate eluates or the final lithium product. Internal reuse of permeate for rinsing also reduces the volume of externally sourced water needed to operate the DLE system 100. In another embodiment, the permeate or retentate is reused as a constituent of a reagent-makeup fluid at a reagent station. Many DLE processes rely on acid, base, oxidizing, or complexing reagents, the performance of which depends on the ionic strength and purity of the diluent. Because the permeate exhibits substantially lower dissolved-solids content relative to the concentrate or feed streams, using at least a portion of the permeate to prepare reagent solutions supports consistent reagent preparation and predictable reaction chemistry while decreasing reliance on externally supplied fresh water.

In some embodiments, the permeate is reused as a constituent of a membrane-cleaning fluid supplied to one or more membranes within the DLE system 100. Membrane-cleaning operations, such as clean-in-place (CIP) with acidic, caustic, or detergent solutions, generally require a clean aqueous base to ensure that the cleaning chemistry performs as intended and does not introduce additional fouling loads. Using at least a portion of the permeate as the aqueous base for the membrane-cleaning fluid provides a stable, low-fouling starting point, whereas using a higher-TDS retentate or untreated produced water could introduce solids and organics that reduce cleaning efficiency or redeposit during the wash cycle. In additional embodiments, the permeate is reused as a constituent of a membrane-backwash fluid applied across a membrane within the DLE system 100. Supplying at least a portion of the permeate as the backwash fluid helps dislodge accumulated foulants while reducing or minimizing re-introduction of dissolved solids, thereby supporting prolonged membrane life and more-stable membrane performance.

In further embodiments, the permeate is reused as a constituent of an electrolysis-makeup fluid applied to an electrochemical unit within the DLE system 100. Electrochemical systems used for pH adjustment, reagent generation, or electrochemical concentration often rely on controlled ionic environments to achieve stable current distribution and efficient operation. Using at least a portion of the permeate as a makeup fluid can provide a consistent, low-scaling aqueous stream suitable for replenishing or diluting electrolytes, whereas retentate streams containing elevated levels of dissolved minerals may trigger scaling or non-uniform current behavior. In other embodiments, the permeate is reused as a constituent of a general DLE system makeup fluid used to maintain hydraulic balance or ionic stability within the DLE system 100. Many stages of the DLE system 100 may require periodic fluid makeup to offset evaporative losses, maintain target conductivity ranges, or stabilize process conditions. Using at least a portion of the permeate as part of the general-makeup fluid helps maintain consistent process conditions, reduces the need to import water from off-site, and reduces or minimizes both the cost and logistical burden of supplying fresh water to remote DLE operations.

In some embodiments, the DLE system 100 generates one or more concentrate streams during polishing, nanofiltration, or osmosis operations, wherein at least a portion of the aqueous solvent has been removed. These concentrate streams, such as a polishing or NF concentrate and the retentate produced at the membrane-separation unit 146, constitute or contain lithium-brine concentrates with elevated levels of dissolved solids, including lithium ions, alkalinity-contributing species, or other solutes of operational value. Because such concentrates retain solutes that would otherwise be lost to disposal, reintroducing at least a portion of the retentate or polishing concentrate back into the DLE system 100 can improve lithium recovery, enhance resource efficiency, or reduce the burden associated with managing high-TDS waste streams. Internal reuse of concentrate is particularly advantageous in remote regions where disposal capacity is constrained, where reinjection limits apply, or where the economic value of the lithium content justifies additional recirculation of enriched streams.

In one embodiment, reintroducing at least a portion of the retentate further comprises using at least a portion of the retentate to adjust alkalinity within the DLE system 100. Certain DLE, membrane-pretreatment, or precipitation actions may require controlled alkalinity levels to stabilize sorbent behavior, manage precipitation equilibria, or maintain the performance of downstream concentration units. In some embodiments, the concentrate inherently contains higher alkalinity and a broad mix of dissolved solids from upstream stages, it can serve as an internal alkalinity source without relying exclusively on external chemical additions. Reusing at least a portion of the retentate for alkalinity control can reduce chemical consumption, lower transportation-associated emissions, and provide a predictable, internally generated conditioning fluid. In some embodiments, reintroducing at least a portion of the retentate further comprises using at least a portion of the retentate to maintain or adjust ionic strength within the DLE system 100, thereby keeping membranes, sorbents, and electrochemical units within their preferred conductivity windows.

In another embodiment, reintroducing at least a portion of the retentate further comprises using at least a portion of the retentate to retain lithium that otherwise would be lost to disposal. Polishing and concentration actions may yield a concentrate that still contains measurable lithium content due to membrane-selectivity limitations or partial-separation efficiencies. In some embodiments, reintroducing at least a portion of the retentate upstream provides the DLE system 100 with another opportunity to extract lithium that remains in the concentrate stream, thereby reducing lithium losses to disposal and increasing the overall lithium-recovery efficiency of the system. In some embodiments, reintroducing at least a portion of the retentate further comprises blending at least a portion of the retentate with a feed stream supplied to the DLE system 100. Such feed blending can moderate feed variability, improve sorbent-loading efficiency, and condition the incoming fluid to a more favorable ionic profile without relying solely on external brine or chemical additions.

In additional embodiments, reintroducing at least a portion of the retentate further comprises circulating at least a portion of the retentate within an internal recirculation loop of the DLE system 100 to reduce waste volume or enhance separation efficiency. Concentrate recirculation may be applied, for example, around polishing, nanofiltration, or osmosis stages to increase overall recovery, or may be used to feed staged concentration units configured to stepwise increase lithium concentration. In such embodiments, reusing at least a portion of the retentate moderates the hydraulic load on waste-disposal infrastructure and lowers overall system water usage.

The reuse of permeate and retentate streams generated at the membrane-separation unit 146, whether as constituents of rinse, reagent-makeup, membrane-cleaning, membrane-backwash, electrolysis-makeup, or general makeup fluids in the case of the permeate, or for alkalinity adjustment, lithium retention, ionic-strength balancing, feed blending, or internal recirculation in the case of the retentate, in some embodiments, may provide operational, environmental, or economic benefits. Integrating these reuse pathways into the DLE system 100 can reduce chemical consumption, lowers transport and disposal costs, or enhance resource efficiency, particularly in geographically remote environments where sourcing fresh water or disposing of high-TDS waste streams is challenging.

In some embodiments, the sorbent composition, laden with the metal, may undergo a rinse one 49. In some embodiments, the rinse one 49 may use a rinsing agent, for example, fresh water, to remove remaining midstream-liquid resources from the sorbent composition. In some embodiments, a fresh-water rinsing agent of three-hundred-thirty-one (331) liters may be used to increase the odds or to ensure that the sorbent composition is sufficiently free of midstream-liquid resources. In some embodiments, the properties of the sorbent composition may be used to separate the sorbent composition from the midstream-liquid resources in the rinse one 49. For example, removing the midstream-liquid resources 106 from the sorbent composition, such as an LMO, may involve applying a magnetic field to use the magnetic properties of the LMO to concentrate the sorbent composition for removal. In some embodiments, the rinsing one 49 may be aided by applying backpressure or a vacuum to the system. While discussed with respect to the rinse one 49, the described techniques may be applied to remove the sorbent composition from midstream-liquid resources, reagents, or any aqueous mediums used in the system 100.

Upon completion of the rinse one 49, the fresh water may be removed and stored in a holding tank 52. In some embodiments, the rinsing agent may be processed to remove pollutants prior to returning the rinsing agent to a holding tank. In some embodiments, the holding tank 52 may be adapted to use back pressure or a vacuum. In some embodiments, the rinsing agent may be transferred to a reverse-osmosis unit 54 to remove the water for storage in a freshwater tank 56. The RO unit reject 57 may be removed from the system 100 in some embodiments. In some embodiments, the system 100 may include monitoring equipment to detect water levels in the freshwater tank 56 and may include a freshwater reservoir source 59 to replenish the freshwater tank 56.

In some embodiments, the sorbent composition containing the metal of interest is exposed to a reagent 52 in an elution step 50. In some embodiments, the reagent 52 may be an acid, for example, hydrochloric acid (HCl) or sulfuric acid (H2SO4). In an embodiment in which the metal of interest is lithium, exposure of the sorbent composition to the reagent, for example, an acid like HCl, will produce LiCl, allowing the LiCl to be subsequently removed from the sorbent composition. While the synthesis of the metal salt lithium chloride has been provided, the acid may be varied to produce the metal salt of choice. For example, use of sulfuric acid (H₂SO₄) may be a preferred reagent when the metal salt lithium sulfate (Li₂SO4) is desired. Of note, the reagent 52 may be mixed in various concentration levels. Once the metal has reacted with the reagent 52, a rinsing agent 142 may remove the desired metal from the sorbent. In some embodiments, the holding tank 52 may be adapted to use back pressure or a vacuum to support the removal of the desired metal from the sorbent. In some embodiments, the rinsing agent 52 is fresh water. Using fresh water allows the metal in its ionic form to be contained within the water. In some embodiments, the LiCl is concentrated within the rinsing agent. The controller is further configured to identify availability of retained rinse and lithium product in solution, to route either stream to the membrane-separation unit 146, and to reintroduce at least a portion of the resulting permeate or retentate to the rinse station and/or reagent station when a reuse specification (including TDS and pH bounds) is satisfied.

In some embodiments, the direct metal-extraction process may continue by further processing the concentrated metal salt 144 created by a reverse-osmosis process implemented by the MSU 146 into an alternative chemical composition. In some embodiments, the metal salt 144 may be lithium chloride and a processing action 150 may convert the lithium chloride into lithium carbonate. The elution output forms a lithium product in solution (e.g., lithium chloride or lithium sulfate in aqueous acid). This lithium product in solution is a lithium-concentrate fluid and, in some modes, is directed from the reagent/elution station to the MSU (e.g., an osmosis station) 146 for dewatering. In some embodiments, the processing action 150 may utilize conventional techniques for processing the metal salt to an alternative metal composition. See Canadian patent number CA 3158831 A1, titled “Production of Lithium Hydroxide and Lithium Carbonate,” which is incorporated in its entirety by reference. Such techniques produce lithium carbonate from lithium chloride, water, and a carbon source. In some embodiments, the carbon source is provided by producing carbon-dioxide nanobubbles in the water.

In some embodiments, the system 100 may be delivered on site to extract metals in ionic form from a metal-containing fluid (e.g., one or more of a subsurface brine, midstream-liquid resources 102, or liquid resources). In such an embodiment, the system 100 may be placed on an easily shippable skid and placed onsite, allowing for a rapidly deployable and customizable solution for extracting metals that does not disrupt other onsite operations. In some embodiments, infrastructure, such as piping with optional valves, allow the metal-containing fluid to be received at a first vessel where the metal-extraction acion 110 may be performed. When batch processing is used, the first vessel for performing the metal-extraction action 110 may include a valve for releasing metal-containing fluid from the first vessel once a cycle time of exposure to the sorbent composition, or conventionally sized sorbent/spinel, and nanobubbles has elapsed. In some alternative continuous-processing embodiments, infrastructure such as piping and flow-control valves direct the metal-containing fluid into a first vessel where the metal-extraction action 110 is performed continuously. The metal-containing fluid flows through the first vessel at a controlled flow rate to maintain an effective contact time with the sorbent composition or conventionally sized sorbent/spinel, optionally with nanobubbles introduced to enhance mass transfer. Rather than cycling the vessel between fill and drain phases, the continuous-flow configuration generates a steady effluent stream in which lithium content has been selectively reduced while the sorbent remains within the first vessel. The skid system 100 may also contain a second vessel containing a rinsing agent plumbed to the first vessel for performing the metal-extraction step 110.

Upon releasing the metal-containing fluid from the first vessel 110, the rinse-one action 49 may be performed, allowing the fluid to be substantially washed from the large-formation composition or conventionally sized sorbent/spinel. In some embodiments the skid system 100 may contain a third vessel plumbed to the first vessel for performing the metal extraction 110 and/or rinse one 49. The third vessel may contain a reagent. In some embodiments, the reagent stored within the third vessel is released into the first vessel to release the metal contained within the sorbent composition, or conventionally sized sorbent/spinel, into a fluid containing the reagent (e.g., the elution step 130). The skid system 100 may be adapted for continuous or batch processing. In some embodiments, the skid system 100 includes at least plumbing and (sometimes necessary) fluid-storage vessels to complete a metal-extraction 110, a first rinse 49, and an elution 50. In some environments, a second rinse 140 may not be needed. A portion of the rinse effluent that is not returned to process is retained as a retained rinse. The retained rinse constitutes a lithium-concentrate fluid and can be routed via plant plumbing to the osmosis station (e.g., MSU 146) for water removal. In some embodiments, the skid system 100 may be adapted with a forward-osmosis system (e.g., when draw solution is plentiful) or an MSU (e.g., a reverse-osmosis system) 146 (e.g., when fresh water is more scarce and on-site water recovery is desired to support direct metal extraction or other on-site needs).

In some embodiments, the skid system 100 may be further adapted to environmental conditions in other ways. For example, additional equipment may be co-located or otherwise installed on the skid to support the first rinse step 49. A holding tank 52 may be connected to an MSU (e.g., a forward-osmosis system or a reverse-osmosis system) 146. In some embodiments where the MSU 146 is an osmosis system, the forward-osmosis system or the reverse-osmosis system 146 may be plumbed to a freshwater tank 56. The freshwater tank 56 may be used to support the first rinse 49, and/or optionally provide a water source for a second rinse 140. In some embodiments, the reverse-osmosis unit 54 may be augmented or replaced with a filtration system (e.g., a nanofiltration system, an ultrafiltration system, or another water-filtration system such as a distillation or deionization system) to clean the rinse of the first rinse 49.

In some embodiments, the system 100 is augmented or adapted at 146 with systems for further concentrating the metal-salt eluate 144. While the system 100 is depicted with an MSU (e.g., a reverse-osmosis unit) 146, in some embodiments, the MSU may be replaced with or augmented with an industrial evaporator, such as one or more of the Saltworks™ product line of saltmaker evaporators. In an alternative embodiment in which energy sources are not plentiful, further concentrating the metal-containing eluate may be accomplished by a low-energy membrane-based separation, such as nanofiltration (NF), or in an evaporation pond.

In some embodiments, the system 100 includes membrane-separation unit 146 configured to receive a recovered process stream selected from (i) a lithium-concentrate fluid (e.g., the lithium salt eluate 144 produced during the reagent/elution sequence), (ii) a lithium-depleted fluid produced by the DLE operation, and/or (iii) a rinse, such as a post-loading (PL) rinse or retained rinse generated during displacement of midstream-liquid resources or reagent from the sorbent. The membrane-separation unit 146 performs membrane separation on the recovered process stream to generate a permeate and retentate. The retentate may be a further-concentrated lithium salt solution (e.g., concentrated LiCl 147) that can be processed downstream to a lithium product such as Li₂CO₃ 150. In some embodiments, the retentate is directed to a holding tank for further processing (e.g., crystallization, evaporation, or sale) or for compliant disposal. The permeate is routed to the fresh-water tank 56 for reuse within the DLE system 100, including (a) for supply to the rinse station as at least a portion of the rinse fluid and/or (b) for supply to the reagent station as make-up water for preparing a reagent solution, with optional blending with external fresh water as needed to meet reuse specifications. To support reuse, in some embodiments, the system includes a first supply connection configured to deliver permeate to the rinse station and a second supply connection configured to deliver permeate to the reagent station. A controller proportions permeate and fresh water from tank 56 to form the rinse fluid and/or a reagent diluent, and reduces the fresh-water draw in proportion to increased permeate availability.

While FIG. 1 depicts an MSU (e.g., reverse osmosis) at 146, other membrane configurations (e.g., forward osmosis, osmotically assisted reverse osmosis, or nanofiltration) may be used, and the concentration duty at 146 may alternatively or additionally be performed by thermal or atmospheric evaporators; in low-energy settings, an evaporation pond can provide the concentration function for the retentate. Monitoring of TDS, pH, and flow enables controlled reintroduction of the permeate and closed-loop balancing of rinse and reagent water inventories.

In some embodiments, the skid system 100 may be further adapted with equipment to convert a metal salt to an alternative chemical composition (e.g., lithium chloride to lithium carbonate). In some embodiments, the skid system 100 includes a nanobubbles pump for injecting carbon dioxide into an eluate containing the concentrated metal salt.

In some embodiments, the DLE extract (e.g., skid) system 100 may include valves and equipment capable of being controlled by a monitoring system 104. The monitoring system 104 may contain a CPU having instructions for requesting sensor information collected by peripheral sensors and/or devices connected to the monitoring system 104. In some embodiments, peripheral sensors may be hardwired to the monitoring system 104 or wirelessly connected to the monitoring system 104. In some embodiments, wirelessly connected peripheral sensors and/or devices directly communicate through the wireless network to the monitoring system 104 and/or communicate through a network router to a local, remote, or otherwise cloud-based monitoring system 104.

In some embodiments, the system 100 includes valves and equipment capable of being controlled by a monitoring system 104. The monitoring system 104 may contain a CPU with instructions for requesting and processing sensor information collected by peripheral sensors and/or devices connected to the monitoring system 104. Peripheral sensors may be hard-wired to the monitoring system 104 or wirelessly connected to the monitoring system, and may communicate directly over a wireless network and/or via a network router to a local, remote, or cloud-based instance of the monitoring system 104. In some embodiments, the monitoring system 104 receives level signals from a holding tank 52, a reverse-osmosis unit 54, and a fresh-water tank 56, and receives quality signals (e.g., conductivity, TDS, pH, temperature) from the MSU permeate stream 152 and from the fresh-water tank 56. Flowmeters on the concentrate outlet 147/150 and MSU permeate outlet 152 of the membrane-separation unit 146, together with valve-position feedback (e.g., V-permeate-to-tank, V-permeate-to-rinse, V-permeate-to-reagent), allow closed-loop control of routing and blending. When the level in the fresh-water tank 56 falls below a setpoint or when a rinse/reagent make-up demand is predicted, the CPU may command valves to divert at least a portion of MSU permeate 152 from the RO unit 54 to the fresh-water tank 56 until a high-level setpoint is reached, while excess permeate is routed to a first supply connection feeding one of the rinse stations and/or to a second supply connection feeding a reagent station. In some embodiments, the monitoring system 104 enforces reuse specifications by comparing permeate-quality measurements (e.g., TDS and pH) against stored thresholds before enabling the supply connections; if the specification is not met, then the permeate is automatically recycled to holding tank 52 for optional polishing or redirected to storage. The CPU may also execute proportional-integral-derivative (PID) blending control to proportion MSU permeate 152 and external fresh water to achieve a target rinse-fluid conductivity and pH, log cumulative volumes sent to the rinse and reagent stations, alarm on abnormal conditions (e.g., high TDS in permeate, RO 54 low recovery, or tank 52 high-high level), and trigger fallback logic (e.g., drawing from a reservoir source when permeate is unavailable). In some embodiments, a vessel receives permeate and includes a fresh-water connection from tank 56 to form a blend that is supplied to the rinse station and/or used as a diluent for reagent make-up at the reagent station.

The monitoring system 104 may track or otherwise sense the chemical properties of the midstream-liquid resources 102, detect the amount of sorbent in the metal-extraction 110, and/or track the contact time of the midstream-liquid resources 102 with the sorbent. In some embodiments, the sensed information may be used to start, automatically, pumps or open valves used to remove the midstream-liquid resources 106. In some embodiments, the monitoring system 104 may selectively control a nanobubbles pump. For example, the nanobubbles pump may be activated, creating gas nanobubbles in the midstream-liquid resources or brine to increase the effectiveness of the sorbent to extract the metal. In some embodiments, the monitoring system 104 may be configured to utilize algorithms capable of improving, even enhancing or optimizing, the use of nanobubbles for the extraction of the metal.

In some embodiments, the CPU further contains instructions for initializing the first rinse step 49. In some embodiments, the monitoring system 104 may initialize the first rinse step 49 upon detecting the removal of the midstream-liquid resources to a midstream-liquid resources (e.g., produced-water) return 106. In an alternative embodiment, the monitoring system 104 may monitor the changing properties of the midstream-liquid resources 102 as the desired metal is extracted. For example, when lithium ions within the midstream-liquid resources 102 are sequestered within a sorbent composition, for example a large-format spinel of LMO, the pH of the midstream-liquid resources becomes more acidic as the lithium-ion concentration decreases in the midstream-liquid resources 102. Such a phenomenon, e.g., a changing property of the midstream-liquid resources 102, may be monitored by the monitoring system 104, and upon the changing property of the midstream-liquid resources 102 reaching a state indicative of an extraction level of the lithium ion, the midstream-liquid resources may be removed and the first rinse step 49 initiated. For example, a volume of midstream-liquid resources containing 200 ppm levels of lithium may have an initial pH of 8.8. Upon reducing the ppm levels of lithium to roughly 13 ppm, the pH may become more acidic, for example a pH of 6.1. In an alternative embodiment, the monitoring system 104 may contain instructions that, when executed by the CPU, cause a magnetic field to be applied to a container where the metal extraction 110 has taken place. The activation of a magnetic field benefits from the inherent magnetic properties of certain sorbents and sorbent compositions. For example, in embodiments where the sorbent composition includes magnetically responsive materials, the application of a magnetic field may facilitate aggregation or settling of a sorbent, such as an LMO spinel, within the container when the produced water return 106 receives a command/instruction to open.

In an embodiment in which the system 100 is placed on a mobile skid, the state information related to the metal extraction 110, the first rinse step 49, and other activities such as the elution step 50, may be transmitted to remote users monitoring the extraction process depicted in the system-workflow of FIG. 1.

In some embodiments, the monitoring system 104 may monitor the quality of the aqueous solution used to perform the first rinse step 49. In some embodiments, nanobubble pumps may be activated to aid in a forward-osmosis process or reverse-osmosis process 54. The use of nanobubbles may accelerate the ability to separate the water from other chemicals present as a result of the first and second rinse steps 49 and 140. Similarly, the monitoring system 104 may actively sense the presence of rinsing agents, the quality of the rinsing agents, the presence of the rinsing agents, the chemical composition of the rinsing agents, or the current state of the rinsing agents as indicated by one or more parameters of the rinsing agents such as a temperature, pressure, pH, or the like. Such information may be communicated to a user, for example, over a private local area network (LAN). In some embodiments, the monitoring system 104 may be adapted with an ethernet port, cellular antennae, or other wireless communications equipment for transmitting and receiving status information to local and remote users.

In some embodiments, the monitoring system 104 may include instructions that, when executed, cause the release of a reagent 52 to the rinsed sorbent containing the metal of interest. The release may activate or otherwise open a valve separating a reagent tank (not depicted) from a tank where the elution step 50 takes place. In some embodiments, the rinse step 49 and elution step 50 occur in the same tank. The monitoring system 104 may contain sensors able to monitor the molar concentration of the reagent 52. In some embodiments, the system 100 may include multiple reagents tuned to the metal sought to be extracted from the sorbent. In some embodiments, the elution action 40 taken by the system 100 may be adapted with equipment for producing nanobubbles to speed up or otherwise enhance the elution step 50. In some embodiments, the monitoring system 104 may include instructions that, when executed, cause the nanobubble equipment to produce nanobubbles of different or varied gas types. In some embodiments, the monitoring system 104 may monitor the effectiveness of the nanobubbles in producing a metal salt, such as lithium chloride.

In some embodiments, the monitoring system may include instructions that, when executed, cause the system 100 to conduct a second rinse step 140. The second rinse step 140 may be initiated by releasing a rinsing agent 142. In some embodiments, the monitoring system 104 may include instructions that, when executed, cause the system 100 to release a concentrated metal salt 144 to a membrane-separation unit 146. At the membrane-separation unit 146, nanobubbles may be used to enhance the ability of reverse-osmosis (RO) equipment to recover the reverse-osmosis permeate, and to further concentrate the metal salt.

In some embodiments, the monitoring system 104 may include instructions that, when executed, cause the system 100 to process 150 the metal salt 144 into an alternative composition containing the metal. In some embodiments, the system 100 may use conventional techniques, for example converting a concentrated lithium chloride 144 salt to a concentrated lithium carbonate 147. Conventional techniques generally produce lithium carbonate from lithium chloride, water, and a carbon source. In some embodiments, the carbon source is provided by transmitting a signal to cause nanobubble equipment to produce gas nanobubbles. In some embodiments, the produced gas nanobubbles are of carbon dioxide gas produced within the water containing the concentrated lithium chloride 148. In some embodiments, the system 100 causes the nanobubble equipment to produce gas nanobubbles into the concentrated lithium chloride 147 without the use of other techniques to produce lithium carbonate.

In some embodiments the system 100 may be fully automated, semi-autonomous, or manually operated. While the system 100 has been described with use of sorbent compositions for direct metal extraction, the nanobubble system may be applied throughout the metal-extraction process 110, the rinse process 49, and the elution process 50 in combination with other conventional direct-metal-extraction techniques. Similarly, several techniques may be used in conjunction with or instead of the aforementioned steps to separate the desired metal from the direct-extraction materials and/or rinsing agent. In some embodiments, the desired metal may be concentrated into the solution using one or more of forward osmosis, reverse osmosis, or selectively permeable membranes.

The exposure may occur at ambient temperature and ambient pressure. In some embodiments, the contact time allows the sorbent to make sufficient contact with the midstream-liquid resources, allowing the sorbent to sequester the metal from the produced-water volume. The contact time that the midstream-liquid resources may be placed in contact with the sorbent may vary in time based on the reactivity of the sorbent and the constituents of the fluid. Sorbent compositions in which a metal ion may occupy a space will actively extract the metal faster as the statistical probability of a metal ion encountering an unoccupied space within the sorbent composition, e.g., an unoccupied space within a sorbent such as Li_{1.33}Mn_{1.67}O4 or Li₄Mn₅O₁₂, is greatest when clean sorbent composition comes in contact with the metal ion. In some embodiments, the midstream-liquid resources may have a reduced first contact time to quickly extract the desired concentration from the midstream-liquid resources. The midstream-liquid resources may then be transferred to a second station for batch processing where the contact time is fine-tuned to “finish” the extraction process.

When enough time has elapsed for the metal to have been removed from the midstream-liquid resources such that a desired concentration of metal within the midstream-liquid resources has been extracted, at the first rinse 49, the method may include removing the midstream-liquid resources from contact with the sorbent. In some embodiments, a rinse recovered from the rinse 49 may contain little or no lithium, for example when the rinse serves primarily to displace midstream-liquid resources or reagent 52 from the sorbent composition. Such rinses, even when substantially lithium-free, may nonetheless be routed to the membrane-separation unit (MSU) 146 as part of the recovered process streams described herein. Once a desired amount of midstream-liquid resources has been removed, at the elution action 50, the method may include rinsing the sorbent. After rinsing the sorbent, at the second rinse 140, the method may include exposing the rinsed sorbent to a reagent to produce at least one metal eluate.

In some embodiments, exposing the volume of midstream-liquid resources to a sorbent for a contact time 110 may be accomplished by batch processing the volume of midstream-liquid resources with the sorbent for the contact time. In some embodiments, batch processing the volume of midstream-liquid resources with the sorbent for the contact time further comprises mixing the volume of midstream-liquid resources with the sorbent for the contact time. In some embodiments, batch processing the volume of midstream-liquid resources with the sorbent for the contact time further comprises testing a concentration level of the at least one metal. In some embodiments, batch processing may be conducted in industrial equipment. In some embodiments, the equipment may be augmented with agitators and other mixing components and techniques to increase the opportunities for the sorbent to come in contact with the volume of midstream-liquid resources.

The contact time may be calculated, although, in some embodiments, the contact time may be based on a direct or an indirect measurement of the change in metal concentration within the system. In some embodiments, batch processing the volume of midstream-liquid resources with the sorbent for the contact time may further comprise testing an indication of a concentration level of the at least one metal using various suitable detection methods. Non-limiting examples of such detection methods include Micro Plasma Induced Breakdown Spectroscopy (MIBS) and Laser Induced Breakdown Spectroscopy (LIBS), both of which are capable of providing real-time, in-situ analysis of metal concentrations. Other suitable methods may include Inductively Coupled Plasma Mass Spectrometry or Optical Emission Spectrometry (ICP-MS/ICP-OES), which offers high sensitivity for detecting trace metals, Atomic Absorption Spectroscopy (AAS) for quantifying specific metal ions and which is effective for rapid, non-destructive elemental analysis, and Nuclear Magnetic Resonance (NMR) spectroscopy (e.g., ⁷Li NMR) for characterizing lithium species or monitoring changes in the chemical environment of metal ions. These methods can be employed individually or in combination to ensure accurate detection and quantification of the desired metal within the midstream-liquid resource, thereby enhancing the subsequent extraction processes. In some embodiments, testing an indication of a concentration level of the at least one metal includes testing a pH level of the midstream-liquid resources. In some embodiments, exposing the volume of midstream-liquid resources to a sorbent for a contact time may further comprise continuous processing the volume of midstream-liquid resources with the sorbent for the contact time. Continuous processing may be monitored to ensure metal extraction occurs at the desired levels.

In some embodiments, continuous processing the volume of midstream-liquid resources with the sorbent for the contact time further comprises testing a concentration level of the at least one metal. In some embodiments, batch processing the volume of midstream-liquid resources with the sorbent for the contact time further comprises testing an indication of a concentration level of the at least one metal. In some embodiments, testing an indication of a concentration level of the at least one metal further comprises testing a pH level of the midstream-liquid resources.

In some embodiments, testing an indication of a concentration level of the at least one metal further comprises testing a flow rate of the midstream-liquid resources. In some embodiments, the sorbent may be a metal-oxide sorbent. In some embodiments, the metal-oxide sorbent may be doped. In some embodiments, the metal-oxide sorbent may be doped with an ion doping agent.

In some embodiments, an ion dopant may further comprise an ion doping agent. For a nonlimiting example of an ion doping agent, see Guotai Zhang, et al. Al and F Ions Co-Modified li1.6mn1.6o4 with Obviously Enhanced Li+ Adsorption Performances, Chemical Engineering Journal, Elsevier, 5 Jul. 2022, https://www.sciencedirect.com/science/article/abs/pii/S1385894722033988, the publication of which is hereby incorporated in its entirety by reference. In some embodiments, the metal-oxide sorbent may be a manganese-oxide-based sorbent. In some embodiments, the manganese-oxide-based sorbent may be doped. In some embodiments, the metal-oxide sorbent may be a manganese-oxide-based sorbent that may further comprise a lithium manganese oxide (LMO). For a discussion of lithium manganese oxides (LMOs) in conjunction with direct lithium extraction (DLE) based on the chemistry of the midstream-liquid resources, see Calvo, Ernesto, (2021), Direct Lithium Recovery from Aqueous Electrolytes with Electrochemical Ion Pumping and Lithium Intercalation, ACS Omega,10.1021/acsomega.1c05516, which is hereby incorporated in its entirety by reference. In some embodiments, the metal-oxide sorbent may be a manganese-oxide-based sorbent that may further comprise a lithium-manganese-oxide (LMO)-type lithium ion-sieve (LIS). For more information on LMO-type LIS, see Ding Weng, et al., Introduction of Manganese Based Lithium-Ion Sieve-A Review, Progress in Natural Science: Materials International, Elsevier, 19 Mar. 2020, https://www.sciencedirect.com/science/article/pii/S1002007119304204, which is hereby incorporated in its entirety by reference.

In some embodiments, the lithium manganese oxide (LMO) may be doped. In some embodiments, the metal-oxide sorbent may be a titanate sorbent. In some embodiments, the titanate sorbent may be doped. In some embodiments, the metal-oxide sorbent may be an aluminate sorbent such as lithium-aluminum-layered double hydroxide (LDH) sorbents (LiClAl₂(OH)₆nH2O) or Aluminum Hydroxide based sorbents (LiX/Al(OH)₃). In some embodiments, the lithium manganese oxide (LMO) may be doped. The doping process can enhance the ion-exchange capacity and selectivity of the sorbent, as described in U.S. Pat. No. 10,266,915 B2, which is incorporated by reference in its entirety and where specific dopants are utilized to modify the sorbent's structure, thereby improving its affinity for target ions. In some embodiments, the metal-oxide sorbent may be a titanate sorbent, which also can be doped to increase its effectiveness in ion-exchange processes. The '915 patent outlines methods for doping metal oxides to enhance their sorption properties, making them more efficient for applications like critical-material extraction. In some embodiments, the metal-oxide sorbent may be an aluminate sorbent, such as lithium-aluminum-layered double hydroxide (LDH) sorbents (LiClAl2(OH)6nH2O) or aluminum hydroxide-based sorbents (LiX/Al(OH)₃). The aluminate sorbent, like the LMO and titanate sorbents, also may be doped to improve its ion selectivity and sorption kinetics. In some embodiments, the contact time may be a function of at least the volume of midstream-liquid resources, the sorbent surface area, and the desired extraction efficiency of the concentration of metal from the volume of midstream-liquid resources. In some embodiments, the aluminate sorbent may be doped. In some embodiments, the contact time may be a function of at least the volume of midstream-liquid resources, a sorbent surface area, and a desired extraction of the concentration of metal from the volume of midstream-liquid resources.

In some embodiments, the at least one metal may be an alkali metal. In some embodiments, the alkali metal may be lithium. In some embodiments, the lithium from the volume of midstream-liquid resources may be at an initial concentration equal to or less than 50 ppm. In some embodiments, the lithium from the volume of midstream-liquid resources may be at an initial concentration equal to or less than 50 ppm and greater than or equal to 3 ppm.

In some embodiments, the lithium from the volume of midstream-liquid resources may be at an initial concentration equal to or less than 100 ppm. In some embodiments, the contact time may be a function of at least the volume of midstream-liquid resources, the mass of sorbent, and a reduction in an initial pH of the midstream-liquid resources to a final pH of the midstream-liquid resources. In some embodiments, an initial pH of the midstream-liquid resources may be a pH less than or equal to 10.0 and greater than or equal to a pH of 5.0.

In some embodiments, a final pH of the midstream-liquid resources may be greater than or equal to a pH of 5.0. In some embodiments, the volume of midstream-liquid resources is exposed to the sorbent during the contact time. In some embodiments, the at least one metal from the volume of midstream-liquid resources may be an alkali metal. In some embodiments, the alkali metal from the volume of midstream-liquid resources may be lithium.

In some embodiments, an initial concentration of the lithium from the volume of midstream-liquid resources may be less than or equal to 50 ppm and greater than or equal to 10 ppm. In some embodiments, an initial concentration of the lithium from the volume of midstream-liquid resources may be greater than or equal to 10 ppm. In some embodiments, the method may include receiving the volume of midstream-liquid resources. In some embodiments, the volume of midstream-liquid resources may be received untreated from an oil-producing well.

In some embodiments, the volume of midstream-liquid resources may be received untreated from an oil-producing well. In some embodiments, the volume of midstream-liquid resources is pre-treated prior to exposing the volume of midstream-liquid resources to a sorbent for a contact time. In some embodiments, pre-treating the volume of midstream-liquid resources prior to exposing the volume of midstream-liquid resources to a sorbent for a contact time further comprises applying, to the midstream-liquid resources, one or more of a mechanical filter, a chemical filter, or a magnetic separation.

In some embodiments, rinsing the sorbent after the contact time elapses further comprises rinsing the sorbent with fresh water after the contact time. In some embodiments, the rinsing method may include returning the fresh water to one or more holding tanks. In some embodiments, the rinsing method may include performing reverse osmosis on the returned fresh water. In some embodiments, exposing the rinsed sorbent to a reagent to produce at least one metal eluate further comprises exposing the rinsed sorbent to an aqueous acid solution.

In the context of releasing lithium from a sorbent, various reagents and mechanisms can be employed depending on the specific system and desired outcomes. Commonly employed acids include hydrochloric acid (HCl) and sulfuric acid (H₂SO₄), which are highly effective due to their strong acidic properties and, therefore, facilitate the elution of lithium ions. In scenarios requiring milder conditions or specific chemical compatibilities, weaker acids such as acetic acid (CH₃COOH), citric acid (C₆H₈O₇), and carbonic acid (H₂CO₃) can be used. Carbonic acid is valuable for its ability to generate bicarbonate ions in solution, which can interact with lithium ions to assist in their release from the sorbent. Alternative methods such as thermal desorption and electrochemical desorption are also viable, where the former relies on heating the sorbent to release lithium, and the latter applies an electrical current for ion release, particularly in systems optimized for electrochemical processes.

In some embodiments, producing a metal-chloride eluate further comprises producing a lithium-chloride eluate. In some embodiments, producing a lithium-chloride eluate further comprises removing the lithium-chloride eluate from the rinsed sorbent. In some embodiments, after producing a lithium-chloride eluate by removing the eluate from the rinsed sorbent, the lithium-chloride solution may undergo further processing to convert the solution into an economically desirable form such as lithium carbonate. This conversion can be achieved through a series of chemical reactions. For instance, the lithium-chloride eluate may be treated with sodium carbonate (Na₂CO₃) to precipitate lithium carbonate (Li₂CO₃), a compound commonly used in various industrial applications, including the production of lithium-ion batteries. In some embodiments, the reaction may involve heating the lithium-chloride solution with sodium carbonate under controlled conditions, leading to the formation of lithium-carbonate precipitate, which then can be filtered, washed, and dried to obtain a high-purity lithium carbonate product suitable for commercial sale. Additionally, alternative conversion methods may involve using lithium hydroxide (LiOH) as an intermediary product, depending on the specific market requirements and intended application of the lithium product. This approach allows for flexibility in the production process, increasing the likelihood, or ensuring, that the final lithium product meets industry standards and customer specifications.

In some embodiments, the method for producing a metal-chloride eluate may include receiving the volume of midstream-liquid resources. In some embodiments, receiving the volume of midstream-liquid resources further comprises receiving the volume of midstream-liquid resources at a wellhead, a saltwater disposal well, a produced-water storage facility, a retention pond, a frac pond, a flowback-fluid collection site, a retention pond, a holding tank, a holding pond, a pump station, a frac tank, and a water-midstream infrastructure site.

In some embodiments, receiving the volume of midstream-liquid resources further comprises pre-treating the midstream-liquid resources. In some embodiments, the volume of midstream-liquid resources further comprises pre-treated midstream-liquid resources. In some embodiments, pre-treating the midstream-liquid resources further comprises running the volume of midstream-liquid resources through a mechanical filter.

In some embodiments, pre-treating the midstream-liquid resources further comprises running the volume of midstream-liquid resources through a chemical filter. In some embodiments, pre-treating the midstream-liquid resources further comprises applying, to the midstream-liquid resources, a multiphase separator. In some embodiments, pre-treating the midstream-liquid resources further comprises applying, to the midstream-liquid resources, at least one of a heat treatment, gravity separation, centrifugal separation, nut shell filtration, or electrochemical separation.

In some embodiments, pre-treating the midstream-liquid resources further comprises applying, to the midstream-liquid resources, a chemical demulsifier. In some embodiments, pre-treating the midstream-liquid resources further comprises applying, to the midstream-liquid resources, a magnetic-separation treatment. In some embodiments, pre-treating the midstream-liquid resources further comprises applying, to the midstream-liquid resources, a magnetic-separation treatment. In some embodiments, pre-treating the midstream-liquid resources further comprises applying, to the midstream-liquid resources, at least one of a dissolved-air flotation, a suspended-air flotation, a diffused-air flotation, or an oxygen-induced-air flotation.

In some embodiments, pre-treating the midstream-liquid resources further comprises applying, to the midstream-liquid resources, an oil skimmer. In some embodiments, pre-treating the midstream-liquid resources may further comprise plasma treating the volume of midstream-liquid resources. In some embodiments, pre-treating the midstream-liquid resources further comprises removing, from the midstream-liquid resources, at least one of a solid, oil, and H₂S.

In some embodiments, pre-treating the midstream-liquid resources further comprises precipitating an iron-containing compound. In some embodiments, pre-treating the midstream-liquid resources further comprises adsorbing sodium from the midstream-liquid resources. In some embodiments, the method may include receiving the volume of midstream-liquid resources at a weir tank.

In some embodiments, a metal being extracted from the midstream volume of liquid resources may be a compound containing, or an ionic form of, at least one of silver, aluminum, gold, boron, beryllium, bismuth, bromine, calcium, cadmium, chromium, cobalt, or copper, manganese, magnesium, potassium, vanadium, or strontium.

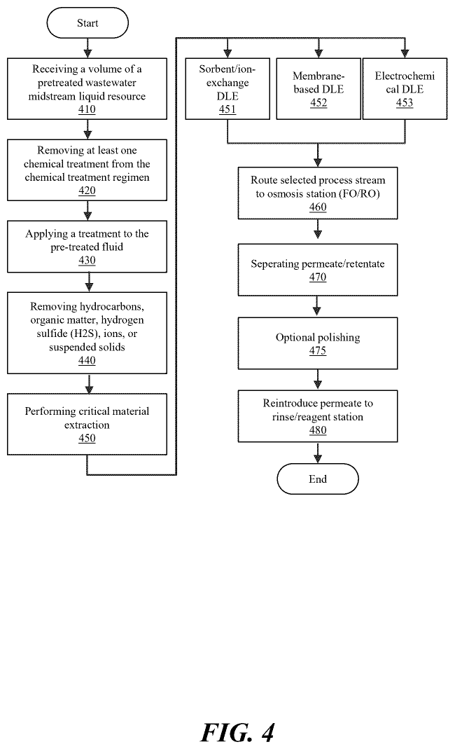

FIG. 4 is a flowchart that describes a method for enhancing extraction of lithium, according to some embodiments of the present disclosure. In some embodiments, at 410, the method may include receiving a volume of a pretreated midstream-liquid resource from a pipeline, a tank, a midstream recycling facility, or a desalination site.

At 420, the method may include removing at least one chemical treatment from the volume of the pretreated midstream-liquid resource using a technique prescribed by a chemical treatment regimen. For example, removing at least one chemical treatment from the chemical treatment regimen 420 may involve using a mechanical filter within the chemical treatment regime. Non-limiting examples of types of mechanical filters include, but should not be limited to, sand filtration, bag filtration, cartridge filtration, disc filtration, membrane filtration, media filtration, activated carbon filtration, ceramic filtration, ultrafiltration, or nanofiltration.

In the pre-treatment process 420, the aforementioned filters may be employed to remove various contaminants and chemical residues from the wastewater midstream-liquid resource. For example, sand filtration utilizes layers of sand to trap and remove particulates, often serving as a primary filtration step in desalination plants. Bag and cartridge filtration systems are commonly used in produced-water recycling facilities to remove larger particles and debris before the water undergoes further treatment. Disc filtration provides high-efficiency filtration by using a series of stacked discs that trap particles as water flows through, making it suitable for applications requiring compact filtration units.

Membrane filtration, including ultrafiltration and nanofiltration, employs semi-permeable membranes to separate smaller particles and dissolved contaminants. Ultrafiltration can remove suspended solids and macromolecules, while nanofiltration targets smaller dissolved substances, including some salts and organic molecules. Media filtration, such as activated carbon filtration, is effective for adsorbing organic contaminants and residual chemicals from the pre-treated fluid. Ceramic filtration systems offer durability and high-temperature resistance, making them suitable for environments with extreme conditions. Each of these mechanical filters plays a role in increasing the likelihood, or ensuring, that the treated liquid resource is adequately purified before further processing, such as critical material extraction or other downstream treatments. In some embodiments, one treatment process 420 is applied. In some embodiments, multiple treatments may be applied to the midstream-liquid resource in a treatment regimen.

After the initial mechanical pre-treatment process 420 has been applied to the wastewater midstream-liquid resource, various residuals may still remain, necessitating further treatment or disposal. These residuals can include trace amounts of the chemical treatments themselves, such as oxidizers, coagulants, or flocculants that were not fully removed during the treatment process. Organic contaminants, including residual hydrocarbons, natural organic matter, or organic acids, might also persist. Additionally, suspended solids that were not completely filtered out, such as fine particulate matter, emulsified oils, or colloidal particles, can remain in the treated liquid. Dissolved ions, including trace metals or salts, may also be present if not entirely captured by ion-exchange resins or membranes during the treatment. The presence of these residuals highlights the need for additional polishing or secondary treatments to ensure the treated liquid meets the desired purity standards before being reused or disposed of.

While removing at least one chemical treatment from the chemical treatment regimen 420 has been described with respect to mechanical-filtration processes, other examples of chemical removal include ion exchange, absorption using activated carbon or other media, biological degradation through bioreactors, chemical precipitation, electrochemical treatments, advanced oxidation processes, distillation, membrane-separation techniques such as reverse osmosis or nanofiltration, or solvent extraction. These methods can be used independently or in combination to effectively reduce or eliminate unwanted chemicals from the pre-treated fluid, thereby enhancing the efficiency and effectiveness of the subsequent treatment stages. In some embodiments, the solvent-extraction process 420 may be utilized to selectively extract desired metals from a liquid resource. In some embodiments, the solvent-extraction process 420 may follow principles similar to those described in U.S. Patent Publication No. 2022/0356545 A1, titled Lithium extractant compounds and their use in selective lithium extraction from aqueous solutions, the contents of which are incorporated herein in their entirety by reference. The publication discusses non-limiting examples of solvent-extraction techniques 420 that may enhance phase separation, reduce emulsion formation, or increase metal-recovery efficiency. By applying solvent-extraction techniques 420, the solvent-extraction process 420 can effectively isolate critical materials from the treated midstream-liquid resource, enhancing or optimizing the overall extraction yield while minimizing the co-extraction of unwanted impurities. These improvements make the process highly suitable for applications requiring precise metal selectivity and high throughput in complex liquid matrices.

At 430, the method may include applying a treatment to the pre-treated fluid. When applying a treatment 430 to the pre-treated fluid 420, certain residuals may remain in the fluid. For illustrative purposes, the pre-treatment regimen 420 includes the application of a biocide and a weir tank. The biocide may reduce bacterial content but could leave behind byproducts of the microbial degradation process, including organic compounds and inactivated cells. The weir tank, primarily functioning to separate immiscible liquids and heavier suspended solids, may still allow finer suspended solids, emulsified oils, or dissolved organic matter to pass through. Additionally, chemical residues from the biocide itself, along with any colloidal particles, minor oil fractions, and dissolved salts, may persist in the pre-treated fluid. Therefore, applying a treatment 430 following the pre-treatment regimen might include addressing these remaining contaminants to increase the likelihood, or to ensure, that the fluid is adequately prepared for critical-material extraction or further processing.

Following the steps referenced as 420 and 430, at 440, the method may involve removing hydrocarbons, organic matter, hydrogen sulfide (H₂S), ions, or suspended solids from the pre-treated fluid. Removing hydrocarbons, organic matter, hydrogen sulfide (H2S), ions, or suspended solids 440 may further purify the midstream-liquid resource prior to performing critical-material extraction 450. Removing hydrocarbons 440 reduces the risk of fouling in downstream equipment, while eliminating organic matter and suspended solids helps prevent clogging and enhances the efficiency of separation processes. Hydrogen sulfide removal mitigates corrosion risks and reduces the presence of sulfur compounds that could interfere with chemical treatments or extraction processes. The removal of ions, particularly those that could form scale or interact negatively with other chemicals, increases the likelihood, or ensures, that the fluid is optimally conditioned for any further processing. This step may utilize a combination of mechanical, chemical, or electrochemical techniques to achieve the desired level of purification.

In some embodiments, removing hydrocarbons, organic matter, hydrogen sulfide, ions, or suspended solids from the pretreated volume of a midstream-liquid resource further comprises applying a mechanical treatment further comprising at least one of a media filtration, bag filtration, cartridge filtration, a ceramic filtration, ceramic ultrafiltration, ceramic nanofiltration, and a divalent filtration system, membrane filtration system, dissolved-air flotation (DAF), suspended-air flotation (SAF), weir tank, media bed, membrane, centrifuge, clarifier, or hydrocyclone.

At 450, the method represented by the flow diagram of FIG. 4 may include performing critical-material extraction, according to an embodiment. The volume of the pretreated midstream-liquid resource may have been treated with a chemical-treatment regimen. At 450, the method may include performing critical-material extraction using the Critical Material Extraction (CME) system 450. The CME system 450 may encompass various techniques tailored to the specific metal of interest and the composition of the pre-treated fluid. Examples of CME systems that may be employed include ion-exchange systems, where ion-exchange resins or media selectively remove metal ions such as lithium from the pre-treated fluid by exchanging them with other cations present on the resin. Another example is solvent extraction, which involves the use of an organic solvent that selectively binds to metal ions, allowing their separation from the aqueous phase. Membrane-based separation systems, including nanofiltration and reverse osmosis, can also be used within the CME system 450 to concentrate metal ions, utilizing lithium-selective membranes to facilitate the extraction of lithium from complex brine solutions. Additionally, electrochemical extraction within the CME system 450 may use an electric field to drive metal ions through a selective membrane or onto an electrode surface, enabling the accumulation of the metal for subsequent harvesting. Lastly, absorption on sorbents may be employed, where metals such as lithium are selectively adsorbed onto sorbent materials like aluminate sorbents such as aluminum hydroxide, with the metal being desorbed or rinsed off using a suitable reagent. These diverse approaches within the CME system 450 provide versatile and effective tools for the extraction of critical materials in various industrial processes.

At 450, the method may include performing critical-material extraction using the Critical Metal Extraction (CME) system 450. This system may incorporate a variety of techniques specifically designed to target and extract critical materials from the pre-treated fluid. Non-limiting examples of these extraction techniques include Direct Lithium Extraction (DLE), which may involve processes such as ion exchange, absorption, or membrane-based separation to selectively remove lithium ions from brines or other liquid resources. For DLE embodiments, fluids generated downstream comprise (i) a lithium-depleted fluid and (ii) a lithium-concentrate fluid selected from a rinse retained after a rinse step and a lithium product in solution formed at a reagent station.

Another non-limiting example is Vanadium Extraction, where techniques like solvent extraction or ion exchange 450 can be employed to isolate vanadium from midstream-liquid resources or other industrial effluents. In a still further non-limiting example, Direct Gallium Extraction may utilize similar solvent-extraction or absorption methods, focusing on selectively isolating gallium from complex mixtures found in wastewater or brine solutions. Lastly, Direct Magnesium Extraction could be achieved using electrochemical processes or selective-precipitation techniques, enabling the recovery of magnesium from midstream liquid resources that contain dissolved metals.

In some embodiments, the system 450 is designed to operate following the removal of pre-treatment chemicals and their byproducts 430, as well as the application of subsequent treatment regimens 440. These steps 420, 430, and 440 serve to purify the midstream-liquid resource, which contains the critical material of interest, to a level that enables efficient commercial-scale CME. In some embodiments, steps 420 may not be needed. In another embodiment, steps 430 and 440 may be performed at a desalination plant or a transfer station prior to step 450. While numerous examples have been described, the chemical constituents and physical properties of the water may dictate the use of different combinations of steps 420, 430, and 440 prior to the CME step 450. In some embodiments, the purification process ensures that the midstream-liquid resource is free from contaminants that could interfere with the extraction processes, such as Direct Lithium Extraction (DLE), Vanadium Extraction, Direct Gallium Extraction, or Direct Magnesium Extraction. These processes, which can be essential for the recovery of valuable critical materials, are made viable on a commercial scale due to the rigorous pre-treatment and purification steps 420, 430, and 440 that precede the CME. This approach maximizes resource recovery while minimizing potential disruptions caused by residual impurities in the liquid resource.

In some embodiments, following steps 420-440, the pre-treated fluid is suitable for direct lithium extraction (DLE). At 450, the method includes selecting a DLE modality and performing extraction in one of three non-limiting modes:

At 451 Sorbent/ion-exchange DLE. The pre-treated fluid is contacted with a sorbent composition (e.g., LMO/LIS, titanate, or aluminate sorbents) in a packed or moving bed for a contact time sufficient to selectively load lithium. After liquid removal, the sorbent is rinsed and/or eluted with a reagent to place lithium in solution, yielding a lithium-concentrate fluid (e.g., retained rinse and/or a lithium product in solution formed at a reagent station) while the contacted liquid constitutes a lithium-depleted fluid.

At 452 Membrane-based DLE. The pre-treated fluid is processed across a lithium-selective membrane (e.g., nanofiltration, ion-selective polymeric or ceramic membranes, tubular or flat-sheet, or optionally osmotically assisted). The membrane operation produces at least one lithium-concentrate fluid as an aqueous liquid generated by the membrane and a complementary lithium-depleted fluid.

At 453 Electrochemical DLE. The pre-treated fluid is circulated through an electrochemical cell employing intercalation/electrosorption electrodes and cation-selective membranes. Lithium is accumulated electrochemically and then released downstream (e.g., by polarity switch or elution) to form a lithium product in solution (a lithium-concentrate fluid) while the raffinate constitutes a lithium-depleted fluid.

Regardless of modality, performing DLE at 450 yields a process stream comprising at least one of: a lithium-depleted fluid in which lithium has been selectively removed from the pre-treated fluid, a lithium-concentrate fluid, or the desired material, in which lithium, or the desired material, is present in solution as a result of the DLE operation (including diffusion into a rinse and/or elution to form a lithium product in solution). The process stream can be collected batchwise or continuously.

Routing to membrane separation at 460-470. In some embodiments, a selected process stream (e.g., the lithium-depleted fluid, rinse fluid, or the lithium-concentrate fluid) is routed to a membrane separation station (forward osmosis, reverse osmosis, nanofiltration, etc.), producing a permeate and retentate. Permeate may be collected in a first vessel and retentate in a second vessel, with optional polishing (mechanical, chemical, or membrane) at 475.

Reintroduction and control (480). At least a portion of the permeate is reintroduced for reuse within the DLE system, including supply as rinse fluid at a rinse station and/or as make-up water for reagent solutions at a reagent station. Reintroduction can be gated by a reuse specification (e.g., TDS and pH measured at the point of reintroduction), with blending to fresh water when desired.

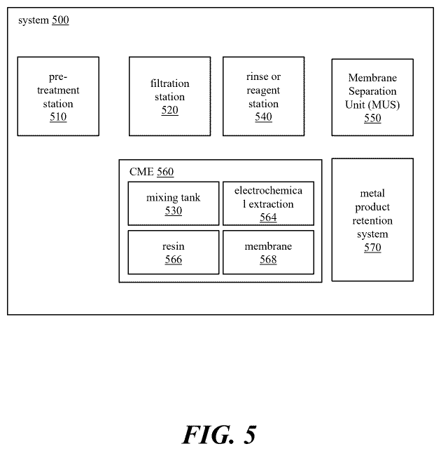

FIG. 5 is a block diagram that describes a system 500, according to some embodiments of the present disclosure. In some embodiments, the system 500 may include several key components and stations designed to enhance or to optimize the extraction of lithium from a liquid resource. In some embodiments, the methods and systems 500 described herein for Critical Material Extraction (CME) may utilize Direct Lithium Extraction (DLE) systems similar to those disclosed in U.S. Non-Provisional Utility patent application Ser. No. 18/601,898, filed on Mar. 11, 2024, and entitled USE OF SORBENT COMPOSITIONS WITH NANOBUBBLES IN PRODUCED WATER APPLICATIONS, the contents of which are incorporated herein by reference in their entirety.

At 510, the method may include a pre-treatment station to receive a volume of midstream-liquid resource from a pipeline, tank, or disposal site. This pre-treatment station can be critical for preparing the wastewater for further processing. The pre-treatment may involve applying various biocides such as oxidizers (e.g., hydrogen peroxide, ozone), glutaraldehyde, quaternary ammonium compounds (QUATs), DBNPA, or THPS to reduce microbial contamination. The treatment may also aim to separate the volume into a retentate and a filtrate. The filtrate, after pre-treatment, typically has a turbidity of less than 20 Nephelometric Turbidity Units (NTU), Total Suspended Solids (TSS) of less than 200 mg/L, a positive Oxidation-Reduction Potential (ORP), and an iron content of less than 5 mg/L.

At the filtration station 520, the system 500 includes a filtration station to receive the pre-treated fluid. In some embodiments, the filtration station 520 is designed to further remove impurities from the fluid, non-limiting examples of which include, but are not limited to, a flocculant, a surfactant, hydrocarbons, oil, grease, suspended solids, flocculated particles, emulsified oils, sediment and silt, particulate matter, organic and inorganic solids, bacteria and pathogens, colloidal particles, sludge, dense particulate matter, sand, metals, organic compounds, or charged particles. The filtration may involve multiple stages such as media filtration, cartridge filters, bag filters, disc filters, or membrane filtration. In some embodiments, the filtration station may include one or more of an above-ground storage tank, a frac tank, a weir tank, a floatation tank, a clarifier, a tank, a separator, a gunbarrel tank, a holding pond, a frac pond, a retention pond, a pipe, a pipeline, a serpentine pipeline. Membrane filtration technologies, including microfiltration, nanofiltration, ultrafiltration, and divalent rejection membranes, may be essential components in the treatment and purification processes in various industries, including metal-extraction technologies like those used in and/or accompanying direct-lithium-extraction (DLE) systems. These membranes are part of a broader class of filtration technologies that are distinguished by their pore sizes and their ability to separate different types of particles and solutes from liquids.

Microfiltration has larger pore sizes (typically 0.1 to 10 microns) and is used primarily for removing suspended solids, bacteria, or some larger organic molecules. Ultrafiltration offers smaller pore sizes (typically 0.01 to 0.1 microns) and is effective at removing proteins, colloids, or other macromolecules. Nanofiltration falls between ultrafiltration and reverse osmosis, with pore sizes typically in the range of 1-10 nanometers, and is used for removing small organic molecules and divalent ions like calcium and magnesium. Divalent-rejection membranes are specialized membranes designed to selectively reject divalent ions while allowing monovalent ions like sodium and lithium to pass through, making them particularly relevant in lithium-extraction processes. In some embodiments, superfiltration membranes, such as those described in the technology by ZwitterCo, Inc., may be utilized. Superfiltration employs zwitterionic copolymers that enhance fouling resistance and broaden the contaminant-removal spectrum beyond that of traditional ultrafiltration. This technology effectively removes oils and other organic materials while maintaining high water-recovery rates. The integration of such superfiltration technology may enhance or optimize the treatment of midstream-liquid resources for subsequent lithium-extraction processes. The complete details of this technology are disclosed in ZwitterCo's product information, which is incorporated by reference in its entirety from https://zwitterco.com/our-products/superfiltration/.

In some embodiments, the filtration station 520 removes hydrocarbons, organic matter, hydrogen sulfide, ions, and suspended solids. Filtration methods may include dissolved-air flotation (DAF), suspended-air flotation (SAF), and weir tanks to ensure the removal of fine particulates and emulsified oils. In some embodiments, the filtration station 520 may employ chemical treatments such as flocculants and coagulants to enhance the removal process.

In an embodiment, the system 500 treats a midstream-liquid resource prior to extracting critical materials by sequestering a desired metal from the pre-treated midstream liquid resource. In some embodiments, the midstream-liquid resource is first treated at a pre-treatment station 510 and subsequently received at a mixing tank 530. The pre-treated fluid is then directed to the critical-material extraction (CME) system 560, and the mixing tank 530. In some embodiments, the mixing tank 530 may contain a sorbent composition for sequestering the desired metal from the pre-treated midstream-liquid resource. Desired metals that may be isolated include, but are not limited to, Aluminum, Magnesium, Potassium, Bromine, Boron, Calcium, Strontium, and Rare Earth Elements (REEs).

The mixing tank 530 is designed to hold the pre-treated fluid and facilitate the interaction with sorbent compositions such as lithium manganese oxide (LMO), lithium-manganese-oxide-type lithium ion-sieve (LIS), titanate sorbents, or aluminate sorbents, thereby enabling the material-extraction process within the CME system. The sorbent compositions may be selectively doped to enhance or to optimize performance based on the specific attributes of the desired metal. Doping agents may be chosen to extend the number of cycles the sorbent composition can withstand when exposed to the midstream-liquid resource or to increase the sorbent's loading capacity or speed. Non-limiting examples of doping agents include Mg²⁺, Sn²⁺, Zn²⁺, Al³⁺, Cr³⁺, Sn⁴⁺, Zr⁴⁺, Ru⁴⁺, V⁵⁺, and Nb⁵⁺.

The material-extraction process isolates the desired metal into a retentate within the material-retention system, while the remaining filtrate is directed to a midstream-release system, enabling further processing or disposal.

Following the absorption process, the mixing tank 530 may be rinsed to recover the desired metal. The rinsing agent, stored within a rinse station 540, may vary depending on the specific sorbent composition and the desired metal. Common rinsing agents stored within a rinse station 540 include water, impurities, or organic solvents like ethanol or methanol. The rinsing process allows the desired metal to be eluted from the sorbent, forming a metal-rich solution. In some embodiments, prior to desorbing the desired metal from the sorbent composition, the rinse station 540 releases water into the mixing tank 530. In some embodiments, the rinse station 540 rinses the sorbent composition with water to remove any impurities from the mixing tank 530 and sorbent composition that may be lingering when the filtrate is removed from the mixing tank 530. In some embodiments the rinse is retained as some of the desired metal may be desorbed from the sorbent composition during the rinse step. The rinse may be received at a membrane separation unit 550 where the water from the rinse may be removed, and desired metal more fully concentrated, for example via reverse osmosis, forming a metal-rich product in solution, such as a lithium product in solution.

For illustrative purposes, in some embodiments the desired metal is lithium. In some embodiments, during the contact time, lithium ions from the midstream-liquid resource are adsorbed within the sorbent composition. The mixing tank 530 increases the likelihood, or ensures, that the conditions are enhanced or optimal for maximum lithium transfer, such as maintaining the appropriate pH, temperature, and level of agitation to enhance or optimize the sequestration of lithium within the sorbent composition. While described as being a mixing tank 530, any vessel that may accept a pre-treated midstream-liquid resource, hold a sorbent composition or be adapted to hold a sorbent composition, and release the pre-treated fluid once a specified contact time elapses, qualifies as a mixing vessel.

While the CME 560 has been described with a mixing tank 530 and a sorbent composition, the CME 560 may be adapted with other metal-extraction systems or combinations of systems and post-absorption treatments. Non-limiting examples of such systems include electrochemical-extraction systems 564, resin-based systems 566, and membrane-based systems 568. These alternative extraction systems can be particularly useful when the pre-treated midstream-liquid resource contains lithium, as they provide different mechanisms for isolating and concentrating lithium from the solution.

In some embodiments, the system 500 may include a reagent station 540, which houses and delivers specific reagents to facilitate the metal-desorption process. The reagent station 540 can dispense various chemical solutions, including acid-based reagents (e.g., HCl, H₂SO₄), or complexing agents, which interact with the sorbent composition to enhance metal recovery from the sorbent. In some embodiments, the reagent includes several constituents, such as an acid like H₂SO₄ to desorb the metal from the sorbent composition and a complexing agent that can form a complex reagent with metal ions by binding to them through multiple sites on the agent, creating a more stable metal complex. In some embodiments, the reagent station 540 may dose the sorbent composition with one or more reagents in parallel or series. Additionally, the reagent station 540 may include desorption monitoring and dosing systems to ensure precise reagent application or metal desorption, thereby enhancing the efficiency of the metal-extraction process and potentially reducing operating costs of the system 500.

The material-extraction process isolates the desired metal into a retentate within the material-retention system, while the remaining filtrate is directed to a midstream-release system, enabling further processing or disposal of the filtrate.

In some embodiments, the electrochemical-extraction system 564 may utilize processes such as electrolysis, where lithium ions in the pre-treated midstream-liquid resource are driven towards an electrode by an applied electric current. This process results in the accumulation of lithium at the electrode, allowing for its extraction and concentration. Non-limiting examples of electrochemical-extraction systems include those utilizing lithium-selective electrodes or specialized electrochemical cells designed to enhance lithium recovery through controlled electrical fields and chemical gradients.

Similarly, resin-based systems 566 may employ ion-exchange resins that are selectively permeable to lithium ions. As the pre-treated midstream-liquid resource passes through a column containing these resins, lithium ions are captured and held by the resin while other ions are allowed to pass through. Once the resin is saturated with lithium, it can be regenerated using an appropriate eluent, resulting in a concentrated lithium solution. Non-limiting examples of resins used in this context include strong-acid-cation-exchange resins or chelating resins designed specifically for lithium recovery.

Membrane-based systems 568, such as those utilizing nanofiltration, ultrafiltration, or membrane-separation units 550, also can be employed to concentrate lithium from the pre-treated midstream-liquid resource. In these systems, the liquid resource is passed through a lithium-selective membrane that allows lithium ions to permeate while rejecting larger ions and molecules. This results in a concentrated lithium solution on one side of the membrane. Non-limiting examples of membranes include polymeric or Divalent Rejection Membranes with pore sizes and surface charges tailored to enhance or to optimize lithium-ion selectivity and passage.

In some embodiments, the extracted lithium then can be further processed and concentrated in the metal-product retention system 560, providing a versatile and adaptable solution for lithium extraction from a variety of midstream-liquid resources.

### Metal Product Retention Station

Once the desorption regimen has been completed, the metal-rich product in solution, or retentate, may be concentrated and collected in a metal-product retention system 560. In some embodiments, the metal-product retention system 560 may be adapted to house and potentially further concentrate the desired metal in solution by incorporating various features and mechanisms designed for this purpose. For illustrative purposes, the system may include a reservoir equipped with agitation systems that maintain uniformity in the metal-rich solution, thereby preventing the settling of solids. Non-limiting examples of concentration mechanisms that could be included in the metal-product retention system 570 are evaporation systems, which could employ controlled heating or vacuum-assisted evaporation to reduce the solution volume, thereby increasing the concentration of the metal.

In some embodiments, the metal-product retention system 570 may include membrane-filtration techniques, such as ultrafiltration, nanofiltration or reverse osmosis, to selectively remove water and other impurities and/or further concentrate the metal ions in the solution. Crystallization also may be utilized, wherein the system could be equipped with a crystallizer that induces supersaturation in the metal-rich solution, leading to the precipitation of the metal as a solid, which can then be collected separately. In some embodiments, evaporation techniques may be applied to the metal-rich product in solution, or retentate, in order to increase the metal concentration. In some embodiments, the metal-product retention system 570, or the system 500, may include a membrane-separation unit 550. The membrane-separation unit 550 may receive the metal-rich product in solution and remove water from the solution, thereby increasing the concentration of the desired metal within the metal-rich product in solution. This action increases the likelihood of, or ensures that, the final metal-rich product meets the required purity and concentration levels for commercial applications. In some embodiments, the metal-rich product in solution may be cycled multiple times to concentrate the metal content. For illustrative purposes, concentrating an initial desired metal concentration of the metal eluate to a desired metal-cycle concentration between 3000-25000 ppm may be performed, thereby forming a further concentrated metal-rich product in solution.

For further system 500 enhancement or optimization, the metal-product retention system 570 may be adapted with automated monitoring and control features that adjust process parameters such as temperature, pressure, or pH to ensure enhanced or optimal metal recovery and concentration. For example, pH adjustment features, scaling inhibitors, or redox potential control systems may be included to maintain the metal in a soluble form or to facilitate its precipitation. Non-limiting examples of these controls might involve adding specific acids or bases to maintain solubility or to initiate controlled crystallization.

In some embodiments, to increase the likelihood of, or to ensure, safety and stability, particularly when handling reactive- or toxic-metal solutions, the metal-product retention system 570 may include features such as inert gas blanketing (e.g., nitrogen) to prevent oxidation or undesired reactions with atmospheric gases. Additionally, the system 500 could be constructed from corrosion-resistant materials to increase the likelihood of, or to ensure, longevity and safety during operation. These features are provided for illustrative purposes and are not intended to be limiting, as other configurations and adaptations may also be employed within the scope of the disclosure.

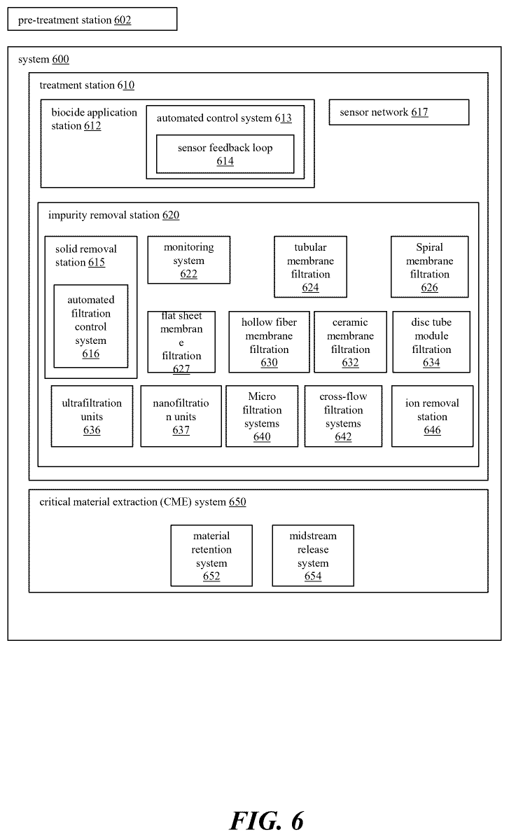

The system 600, as illustrated in FIG. 6, is configured to receive a pre-treated midstream-liquid resource from a pre-treatment station 602, which may process a midstream-liquid resource before critical-material extraction. In some embodiments, a pre-treatment station 602 may receive the midstream-liquid resource from a desalination plant. Additional non-limiting examples include produced-water recycling facilities, saltwater disposal facilities, midstream recycling facilities, frac-water-treatment plants, municipal wastewater-treatment plants, industrial-wastewater treatment plants, brine-treatment facilities, centralized treatment plants, evaporation ponds, injection wells, oilfield-water-handling facilities, an unconventional geobrine station, and mobile water-treatment units.

In some embodiments, the pre-treatment station 602 may receive a volume of midstream-liquid resource from sources such as pipelines, tanks, or disposal sites. Examples of the pre-treatment station 602 include equipment such as above-ground storage tanks, frac tanks, weir tanks, flotation tanks, clarifiers, separators, gunbarrel tanks, holding ponds, frac ponds, retention ponds, pipes, pipelines, or serpentine pipelines.

The pre-treatment station 602 may apply various pre-treatment regimens to the midstream-liquid resource, including the application of biocides, chemical treatments, and processes for solid and residue removal. In some embodiments, biocides may include oxidizers such as hydrogen peroxide, ozone, bubbled oxygen, nanobubbled oxygen, carbon dioxide (CO₂), aeration, chlorine, chlorine dioxide, sodium hypochlorite, peracetic acid, potassium permanganate, or calcium hypochlorite, as well as other biocides like glutaraldehyde, Quaternary Ammonium Compounds (QUATs), DBNPA (2,2-Dibromo-3-nitrilopropionamide), or THPS (Tetrakis (hydroxymethyl) phosphonium sulfate). In some embodiments, the pre-treatment station 602 may remove contaminants such as hydrocarbons, organic matter, hydrogen sulfide, ions, or suspended solids. Solids may be removed by a any number of methodologies including mechanical treatments like media filtration, cartridge filters, bag filters, disc filters, membrane filtration, activated carbon, dissolved-air flotation (DAF), suspended-air flotation (SAF), weir tanks, or settling tanks.

In some embodiments, the pre-treatment process may further include separating the midstream-liquid resource into a retentate and a filtrate. The filtrate may exhibit specific properties, such as a turbidity of less than 20 Nephelometric Turbidity Units (NTU), Total Suspended Solids (TSS) of less than 200 mg/L, a positive Oxidation-Reduction Potential (ORP), and an iron content of less than 5 mg/L.

For illustrative purposes, the retentate from the pre-treatment station may include a variety of substances that have been removed from the midstream liquid resource. These substances may include one or more of suspended solids, such as silt, sediment or other insoluble particles; hydrocarbons, including oil, grease, or other organic compounds; and flocculated particles, which are aggregates formed during the flocculation process and that may include both organic and inorganic materials. Additionally, coagulated particles, larger aggregates formed through coagulation processes involving chemical additives like aluminum sulfate or ferric chloride, may also be present in the retentate. The retentate may further contain iron precipitants, which are iron compounds precipitated out of the solution, typically in the form of iron hydroxides. Emulsified oils, biological contaminants such as bacteria and pathogens removed using biocides, or surfactants separated from the liquid resource during treatment may also be found in the retentate. Additionally, the retentate may contain organic matter, including decomposed plant and animal material, and chemical residues resulting from prior chemical treatments, such as residual oxidizers, coagulants, or other treatment chemicals. In some embodiments, non-limiting examples of the retentate includes a flocculant, a surfactant, hydrocarbons, oil, grease, suspended solids, flocculated particles, emulsified oils, sediment and silt, particulate matter, organic and inorganic solids, bacteria and pathogens, colloidal particles, sludge, dense particulate matter, sand, metals, organic compounds, or charged particles. In some embodiments, the retentate is a particle with an average size greater than one micron in diameter. These substances within the retentate are typically concentrated and removed during the pre-treatment process to prepare the liquid resource for further treatment or extraction processes.

In some embodiments, the pre-treatment station 602 may apply a pre-treatment regimen to the midstream-liquid resource to produce a pre-treated midstream-liquid resource. This may include at least one of a biocide, a flocculant, a coagulant, or a surfactant. In some embodiments, the filtration system (e.g., as controlled by the automated filtration control system 616 may be at least one of a hydrocyclone, a media filter, a ceramic filtration, an u a nanofiltration, a ceramic ultra-nano filtration, or a polymer-based membrane unit. In some embodiments, the pre-treatment station 602 may alter the cationic or anionic constituency of the resource using a media bed, ion-exchange process, or ceramic- or polymeric-membrane filtration. The pre-treatment process also may involve concentrating the resource's Total Dissolved Solids (TDS) using a desalination process that incorporates membrane- or thermal-evaporation technologies. While efforts may be made at the pre-treatment station 602 to improve the quality of the midstream-liquid resource, the goal of facilities containing a pre-treatment station 602 have not historically been incentivized to deliver a pre-treated midstream-liquid resource improved or optimized for Critical Material Extraction. Treatment regimens vary substantially, potentially complicating the predictability as physical attributes of midstream solutions further vary from location to location. Enhancing the predictability of the physical attributes of the pre-treated midstream-liquid resource prior to a critical-metal extraction system 650 is a goal of an embodiment of the present disclosure.

In some embodiments, the treatment station 610 may include a biocide application station 612 where a biocide, such as an oxidizer, is applied to the pre-treated-liquid resource, and an impurity-removal (e.g., treatment) station 620 equipped with a solid-removal station 615, for example, a dissolved-air flotation (DAF), suspended-air flotation (SAF), or a weir tank where solids are removed from the pre-treated midstream-liquid resource. A biocide application station 612 increases the likelihood of, or ensures, satisfactory ORP values, while the impurity-removal station 620 may include multiple pieces of equipment that are running in series to reduce TDS values and remove the oxidizers applied to the incoming pre-treated midstream-liquid resource through the application of a treatment regimen.

In some embodiments, treatment station 610 applies a treatment regimen to the midstream-liquid resource to produce a treated midstream-liquid resource. Non-limiting classes of treatments include a biocide, flocculant, coagulant, or surfactant. Non-limiting examples of biocides include hydrogen peroxide, ozone, bubbled oxygen, nanobubbled oxygen, aeration, chlorine, chlorine dioxide, sodium hypochlorite, peracetic acid, potassium permanganate, calcium hypochlorite, Glutaraldehyde, Quaternary Ammonium Compounds (QUATs), 2.2-Dibromo-3-nitrilopropionamide (DBNPA), Tetrakis (hydroxymethyl) phosphonium sulfate (THPS), isothiazolinones, formaldehyde, bromine, iodine, copper sulfate, or chlorhexidine. The physical attributes of the midstream-liquid resources vary over the life of a well and often necessitate varying the treatment regimen applied to the midstream-liquid resource to account for the variation in physical attributes of the midstream-liquid resource over time. For example, the midstream-liquid resource TDS value may increase over time. The increase in TDS may be accounted for by adjusting the treatment regimen to remove this excess TDS to return the pre-treated TDS values to a TDS value in-line with the early life of the well.

In some embodiments, the operation of the biocide-application station 612 may be enhanced through the use of an automated control system 613 to dose the pre-treated-liquid resource according to a treatment regimen. While a biocide-application station 612 is illustrated, the treatment station 610 will add something not present in the pre-treated midstream liquid, for example, a magnetic field or flocculant, or increase the presence of a compound in the liquid resource, like a coagulant. Augmenting the automated control system 613 with a sensor network 617 and sensor feedback loop 614 may monitor the volume of the dose administered as part of the treatment regimen or time treatment and dynamically adjust the applied dose, for example, timing the application of a thermal heat source or heat sink. In another embodiment, the combination of the automated control system 613 with a sensor network 617 and sensor feedback loop 614 applies a treatment regimen while the sensor feedback loop 614 monitors for the presence of byproducts, the absence of byproducts, or monitors the concentration of the dosing agent (e.g., flocculant, coagulant, biocide) present in the liquid resource. In some embodiments, a sensor feedback loop 614 is automated in software to take the sensor data from the environment/vessel containing the liquid resource from one or more sensors in the sensor network 617 to activate or deactivate a mechanical mechanism (e.g., a valve or pump) dosing the liquid resource. In some embodiments, the sensor network 617 may comprise a single sensor that is integrated with the automated control system 613 or a mechanical mechanism (e.g., a valve, pump, heater, pressure valve) that governs the administration of the treatment. In some embodiments, a sensor network 617 is not integrated into the mechanical mechanism of the biocide-application station 612, but provides sensor information to the automated control system 613 that informs the commands generated to control the mechanical mechanism as part of the sensor feedback loop 614.

Additionally, the treatment station 610 may include an impurity-removal station 620 to remove impurities from the pre-treatment station 602, or impurities and byproducts produced when the treatment regimen is applied at treatment station 610. Treatment station 610 may include filtration systems suitable for removing treatments and their byproducts. Non-limiting examples of filtration systems include tubular-membrane filtration 624, spiral-wound membrane filtration 626, flat-sheet-membrane filtration 627, hollow-fiber-membrane filtration 630, ceramic-membrane filtration 632, disc-tube-module filtration 634, ultrafiltration units 636, nanofiltration units 638, microfiltration systems 640, cross-flow filtration systems 642, or ion-removal station 646. Impurity-removal station 620 components increase the likelihood, or ensure, that the midstream-liquid resource is adequately treated, removing or neutralizing impurities that hinder the critical-material-extraction system 650. The critical-material-extraction (CME) system 650 may include a material-retention system 652 to aggregate the metal-containing liquid-resource product and a midstream-release system 654 to remove the midstream-liquid resource from the system 600 once the desired metal has been extracted from the critical-material-extraction (CME) system 650.

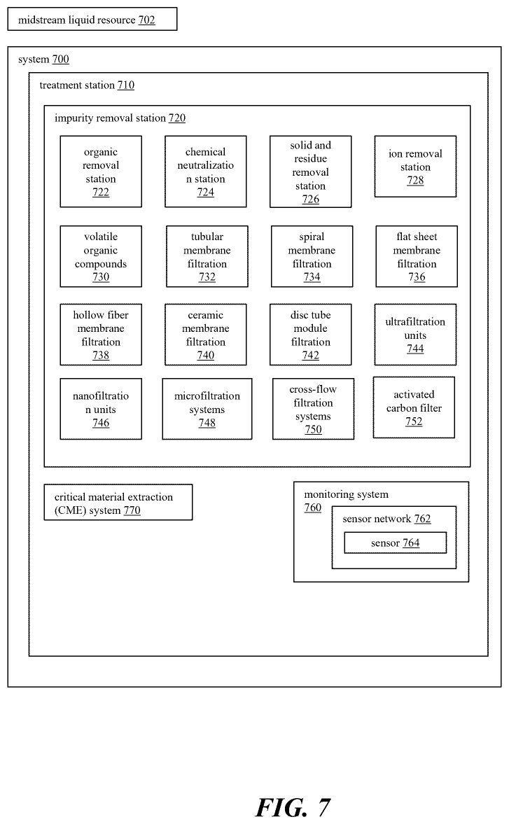

Turning now to FIG. 7, in some embodiments, a system 700 receives a midstream-liquid resource 702 that is untreated. Upon receiving the untreated midstream-liquid resource, the midstream-liqud resource is exposed to a treatment or treatment regimen at the treatment (e.g., impurity-removal) station 710. The treatment station 710 may apply one or more of a chemical, biological agent, flocculants, surfactants, or coagulants to the midstream-liquid resource. In some embodiments, the treatment station 710 applies flocculants, non-limiting examples of which include polyacrylamide, polyethyleneimine, PolyDADMAC (Polydiallyldimethylammonium chloride), starch-based flocculants, and chitosan. Non-limiting classes of coagulants include polyaluminum chloride, aluminochlorohydrate, aluminum sulfate, ferric chloride, and sodium aluminate, among others. In some embodiments, the treatment station 610 applies surfactants, non-limiting examples of which may include ethoxylated nonylphenols, linear alkylbenzene sulfonates, alkyl sulfates, alkyl polyglucosides, sodium lauryl ether sulfate, and various other compounds.

Upon treatment of the midstream-liquid resource, the presence of impurities within the system 700 is addressed to increase the likelihood of or to ensure proper functioning of the critical-material-extraction (CME) system 770. The removal of impurities may be accomplished within the impurity-removal station 720. In some embodiments, equipment of the impurity-removal station 720 may be collocated within the vicinity of each other, or connected through pipework. The nature of the untreated midstream-liquid resource received at the system 700 often requires multiple types of equipment to effectively remove impurities.

The system 700, as illustrated in FIG. 7, is designed to treat a midstream-liquid resource 702 by applying a comprehensive pre-treatment regimen to increase the likelihood of, or to ensure, that the liquid resource is adequately prepared for critical=material-extraction at the critical-material-extraction (CME) system 770. The system 700 includes a treatment station 710 and an impurity-removal station 720, each equipped with various types of equipment selections tailored to address different impurities commonly found in untreated midstream-liquid resources.

The treatment station 710 is responsible for applying an initial pre-treatment regimen to the midstream-liquid resource. This treatment station 710 may incorporate various technologies to remove contaminants present in the liquid resource. For instance, the treatment station 710 may utilize equipment within an impurity-removal station 720. The impurity-removal station 720 may remove one or more of a biocide, flocculant, coagulant, or surfactant to reduce microbial activity, promote the aggregation of fine particles, and/or enhance the removal of suspended solids. These treatments condition the midstream-liquid resource 702 by stabilizing and/or reducing contaminants that could hinder subsequent purification and extraction processes.

Following pre-treatment at station 710, the midstream-liquid resource 702 is further processed at the impurity-removal station 720. In some embodiments, the impurity-removal station 720 houses one or more specialized equipment options, each tailored to remove classes of, and in some instances specific, impurities:

Organic Removal Station 722: This station may include activated carbon filters and membrane-filtration systems designed to remove organic compounds and residual chemicals from oil-recovery processes. These technologies are important or essential for increasing the likelihood, or ensuring, that organic pollutants do not interfere with the extraction of critical materials.

Chemical Neutralization Station 724: This station can utilize chemical-oxidation units and ozone-treatment units to neutralize and break down chemical agents present in the midstream-liquid resource. Neutralizing these chemicals is important or crucial for maintaining the efficiency of downstream extraction processes.

Solid and Residue Removal Station 726: Equipped with coagulation units, flocculation units, and electrocoagulation units, this station effectively removes suspended solids, flocculated particles, and chemical residues. The removal of these impurities is important or vital for preventing clogging and maintaining the integrity of the filtration systems used in subsequent stages.

Ion Removal Station(s) 728: This station (these stations) may employ ion-exchange systems and deionization units to remove dissolved ions and chemicals from the midstream-liquid resource. By reducing the ionic load, this station (these stations) prepare the liquid resource for the critical-material-extraction (CME) system 770.

Volatile Organic Compounds (VOC) Stripping Station 730: This station is designed to remove VOCs from the midstream-liquid resource using stripping towers and columns. The elimination of VOCs is important to increase the likelihood, or to ensure, that these compounds do not volatilize during subsequent processing steps, which could pose safety and environmental concerns.

In some embodiments, the impurity-removal station 720 may include advanced membrane-filtration technologies such as tubular-membrane filtration 732, spiral-membrane filtration 734, flat-sheet-membrane filtration 736, hollow fiber membrane filtration 738, ceramic membrane filtration 740, disc-tube-module filtration 742, ultrafiltration units 744, nanofiltration units 746, microfiltration systems 748, and/or cross-flow filtration systems 750. These membrane systems are particularly effective in removing fine particulates, dissolved solids, and other contaminants from the liquid resource. The choice of membrane technology depends on the specific characteristics of the midstream-liquid resource and the desired level of purity.

Once the midstream-liquid resource has been treated and subject to impurity removal at stations 710 and 720, it is sufficiently purified for the extraction of critical materials at the CME system 770. The CME system 770 then can efficiently isolate and concentrate critical metals, such as lithium, from the treated liquid resource, increasing the likelihood of, or ensuring, high recovery rates and product purity.

In some embodiments, the treatment station 710 may include a monitoring system 760 and at least one system-automation subcomponent. The monitoring system 760 may transmit a command to the subcomponent. In some embodiments, the treatment station 710 may include a sensor network 762, and at least one sensor 764. The sensor network 762 may be used to monitor a physical attribute of the midstream-liquid resource while the treatment regimen is being applied thereto. In some embodiments, the sensed attribute may be at least one of a flow rate, pressure, temperature, conductivity, total dissolved solids, chemical concentration, elemental concentration, H₂S concentration, and/or turbidity of the pre-treated midstream-liquid resource. The at least one sensor 764 of the sensor network 762 may transmit data indicative of the of the sensed attribute to the monitoring system 760. The monitoring system 760 may process received data from the sensor 764 and transmit a command either to further process the midstream-liquid resource or to release the treated midstream-liquid resource to the critical-material-extraction (CME) system 770.

In some embodiments, the impurity-removal station 720 includes specialized sub-stations, each designed to address specific impurities present in the midstream-liquid resource 702. For example, the organic-removal station 722 may employ activated carbon filters or membrane-filtration systems to remove organic compounds and chemicals used in oil-recovery processes. The chemical-neutralization station 724 may use equipment such as chemical-oxidation units or ozone-treatment units to neutralize and break down chemical agents within the midstream-liquid resource 702. Once the midstream-liquid resource 702 is chemically neutralized, in some embodiments, it is pumped to a solid-and-residue-removal station 726. In some embodiments, the solid-and-residue-removal station 726 may include several pieces of equipment specifically designed to remove one or more of coagulants, flocculants, suspended solids, flocculated particles, or chemical residues from the midstream-liquid resource 702. The solid-and-residue-removal station 726 may include coagulation units, flocculation units, or electrocoagulation units that effectively precipitate and aggregate small particles within the liquid resource, making these chemicals and their byproducts easier to remove. Once these substances are coagulated or flocculated, they can be further separated using devices such as a dissolved-air flotation (DAF) unit 748, a suspended-air flotation (SAF) unit 750, or a hydrocyclone 752, all of which are designed to separate lighter flocculated particles from the liquid resource by inducing buoyancy or centrifugal forces.

In some embodiments, the ion-removal station 728 might incorporate ion-exchange systems and deionization units to extract dissolved ions and chemicals. For the removal of volatile organic compounds (VOCs), the VOC stripping station 730 could employ stripping towers or stripping columns to eliminate VOCs from the liquid resource.

Moreover, advanced filtration technologies are also integrated within the impurity-removal station 720. These technologies in some embodiments may include tubular-membrane filtration 732, spiral-membrane filtration 734, flat-sheet membrane filtration 736, hollow-fiber membrane filtration 738, ceramic-membrane filtration 740, and/or disc-tube-module filtration 742. These units are specifically designed to handle various filtration needs, including ultrafiltration units 744, nanofiltration units 746, microfiltration systems 748, and cross-flow filtration systems 750. Each filtration system reduces contaminants, increasing the likelihood, or ensuring, that the treated midstream-liquid resource is adequately prepared for critical-material extraction.

The system 700 is further enhanced by the monitoring system 760, which includes a sensor network 762 with sensors 764 that monitor the physical qualities of the midstream-liquid resource 702. This monitoring can be important or crucial for increasing the likelihood, or ensuring, that the impurity-removal processes effectively prepare the liquid for the CME system 770. For instance, sensors within the monitoring system 760 may measure the Total Dissolved Solids (TDS) and Oxidation-Reduction Potential (ORP) of the liquid resource. Based on the sensor data, the system can adjust the operation of the impurity-removal station 720 to achieve a pre-treated liquid with a turbidity of less than 20 Nephelometric Turbidity Units (NTU), Total Suspended Solids (TSS) of less than 200 mg/L, a positive ORP, and/or an iron content of less than 5 mg/L. In some embodiments, clarifiers, centrifuges, media filters, sand filters, or sock filters may further polish the liquid resource by removing any remaining suspended solids or residues, increasing the likelihood, or ensuring, that the midstream-liquid resource is free of these impurities before being passed on to subsequent processing stages, such as the critical-material-extraction (CME) system 770.

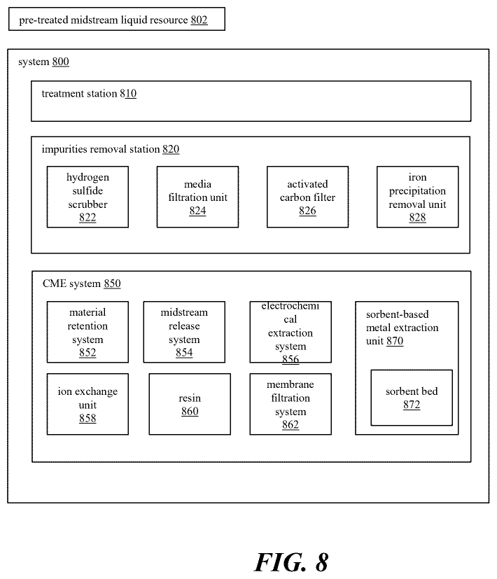

FIG. 8 is a block diagram of a system 800 according to some embodiments. The system 800 enhances or optimizes the extraction of desired metals, such as lithium, from a pre-treated midstream-liquid resource 802. The pre-treated midstream-liquid resource 802 enters the system 800, which includes three processing stations: a treatment station 810, an impurities-removal station 820, and a critical-material-extraction (CME) system 850.

In some embodiments, the treatment station 810 of the system 800 receives the midstream-liquid resource from various sources, such as a pipeline, tank, or disposal site. In treatment station 810, a pre-treatment regimen is applied to the midstream-liquid resource. This regimen may include applying biocides, oxidizers, or other chemical treatments to reduce microbial activity and prepare the midstream-liquid resource for further processing. Non-limiting examples of biocides include hydrogen peroxide, ozone, chlorine, and glutaraldehyde. The pre-treatment process 810 increases the likelihood, or ensures, that the midstream-liquid resource 802 is in a suitable state for impurity removal and subsequent critical-material extraction. In another embodiment, the treatment station 810 receives a liquid resource 802, which may originate from wastewater from a midstream system, disposal well fluid, water-recycling system, or a desalination system. Upon receipt, the liquid resource undergoes one or more treatments, which may include chemical, mechanical, biological, thermal, or electrochemical processes. These treatments are applied to separate the liquid resource into a retentate and a filtrate. The treatment station 810 reduces one or more of turbidity, total suspended solids (TSS), or other contaminants, thereby producing a pre-treated liquid resource suitable for further processing.

In some embodiments, the system 800 may include a solar heating component integrated within the treatment station 810 or the impurities-removal station 820. The solar heating component may elevate the temperature of the midstream-liquid resource, thereby enhancing the efficiency of thermal-based treatment processes. For instance, solar heating could be applied prior to chemical treatment 810 to improve reaction kinetics or within the subsequent impurities-removal station 820 to facilitate the removal of certain impurities. The integration of solar heating offers an energy-efficient solution that supports the environmental sustainability of the system 800 while maintaining its operational effectiveness.

After pre-treatment, the midstream-liquid resource 802 enters the impurities-removal station 820. The impurities-removal station 820 further purifies the pre-treated liquid by removing residual impurities that could interfere with the subsequent critical-material-extraction process. The impurities-removal station 820 may include various subcomponents, such as a hydrogen-sulfide scrubber 822, media-filtration unit 824, activated carbon filter 826, and/or iron-precipitation-removal unit 828. These units collectively target and eliminate different contaminants, including hydrogen sulfide, suspended solids, organic matter, and iron precipitates, increasing the likelihood, or ensuring, that the liquid resource is in an improvied or optimal state for critical-material extraction.

In some embodiments, the impurities-removal station 820 may include additional components such as an ammonia-absorption column. The ammonia-absorption column may be used to remove ammonia or other nitrogenous compounds from the midstream-liquid resource. The impurities-removal station 820 could operate within a chemical-neutralization station or as part of a broader chemical-treatment regimen. The use of an ammonia-absorption column increasing the likelihood, or ensures, that specific gaseous or dissolved impurities are effectively captured and neutralized before the liquid resource 802 undergoes further processing or is subjected to critical-material extraction within the CME system 850.

In some embodiments, the hydrogen-sulfide scrubber 822 removes hydrogen sulfide, a common contaminant in midstream-liquid resources 802. Hydrogen sulfide (H₂S) can have several detrimental effects on CME systems such as the CME system 850, such as lithium-manganese oxide-based (LMO) sorbents used in Direct Lithium Extraction (DLE) processes. H₂S can react with the manganese in the LMO sorbent, leading to the formation of manganese sulfide (MnS), which diminishes the effectiveness of lithium absorption. This reaction can degrade the structural integrity of the LMO sorbent, reducing its efficiency and lifespan.

In some embodiments, the impurities-removal station 820 may include the media-filtration unit 824. The media-filtration unit 824 may use different types of media to filter out suspended solids, organic matter, and/or other particulates. Non-limiting examples of media include sand media, granular activated carbon (GAC), anthracite coal, zeolite, or crushed glass. In some embodiments, the impurities-removal station 820 may include an activated-carbon filter 826. Activated-carbon filter 826 adsorbs organic compounds, residual chemicals, and other impurities from the midstream-liquid resource 802. In some embodiments, the impurities-removal station 820 may include an iron-precipitation-removal unit 828. Iron-precipitation-removal unit 828 may target and remove iron precipitates, which can interfere with the efficiency of the critical-metal-extraction system 850. The impurities-removal station 820 increasing the likelihood, or ensures, that the midstream-liquid resource 802 is purified to the required standards, with reduced turbidity, lower levels of suspended solids, and a positive Oxidation-Reduction Potential (ORP) before passing to the critical-material-extraction (CME) system 850.

Once the midstream-liquid resource 802 has achieved a minimum required level of purification, it enters the CME system 850, where the desired metal is extracted. The CME system 850 includes a material-retention system 852 and a midstream-release system 854. The material-retention system 852 is responsible for retaining the targeted metal ions for extraction, while the midstream-release system 854 releases the treated liquid resource after the extraction process, increasing the likelihood of, or ensuring proper disposal or recycling of the remaining liquid. The material-retention system 852 is designed to capture and concentrate the desired metal from the liquid resource. Various extraction units may be used within the CME system 850, including one or more of an electrochemical-extraction system 856, an ion-exchange unit 858, a resin 860, a membrane-filtration system 862, and a sorbent-based metal-extraction unit 870.

In some embodiments, the CME system 850 includes an electrochemical-extraction system 856. The electrochemical-extraction system 856 in the CME system 850 applies electrical currents to selectively extract metal ions from a solution. This process, known as electrochemical extraction, involves using electrodes to drive a redox reaction that separates metal ions from the treated midstream-liquid resource. The extracted metal ions are then deposited onto the electrode or converted into a recoverable form. This method is particularly useful for selectively extracting metals such as lithium, cobalt, or nickel from complex solutions like those found in direct-lithium-extraction (DLE) systems. That electrochemical-extraction systems can be tuned to target, selectively, specific metal ions is supported by research into redox-mediated electrochemical processes and the manipulation of electrode potentials. These systems leverage controlled electrochemical environments to attract or repel ions preferentially, allowing for the selective recovery of desired metals while leaving others unaffected. For example, research demonstrates how tuning electrode potentials can enable the selective extraction of metals like lithium while minimizing interference from other ions in complex solutions. See the entire contents of the article titled Redox-mediated electrochemical liquid-liquid extraction for selective metal recovery, published in Nature Chemical Engineering (2024), available at https://www.nature.com/articles/s44286-024-00049-x, the contents of which are hereby incorporated by reference as if fully set forth herein.

In some embodiments, the electrochemical-extraction system 856 might work alongside other systems, such as ion-exchange units 858 or sorbent beds 872, to enhance the overall extraction efficiency and purity of the desired metal. In some embodiments, the CME system 850 includes an ion-exchange unit 858. Ion-exchange units 858 may be used for lithium extraction. The selection of the ion-exchange resin for the ion-exchange units 858 and its functional groups can be selected based on the specific metal ions present in the treated midstream-liquid resource, increasing the likelihood, or ensuring, that the ion-exchange unit 858 effectively isolates the desired metal while reducing or minimizing the extraction of non-target ions.

In some embodiments, the CME system 850 includes a resin 860. Resins 860 can be used to extract various metals from a treated midstream-liquid resource, including, but not limited to, lithium, magnesium, copper, nickel, and/or rare earth elements. The selection of resin 860 depends on the specific target metal and the characteristics of the liquid resource. For example, ion-exchange resins are effective for lithium and magnesium, while chelating resins may be preferred for metals like copper and nickel. The functional groups within resin 860 can be tailored to enhance or to optimize metal-ion affinity and selectivity, increasing the likelihood of, or ensuring, efficient isolation of the desired metal while reducing or minimizing interference from other ions in the solution.

In some embodiments, the CME system 850 includes a membrane-filtration system 862. The choice of membrane-filtration system 862 depends on the target metal and the required filtration precision. For instance, nanofiltration membranes may be used for lithium and magnesium, while ultrafiltration or reverse osmosis membranes are effective for isolating copper and nickel metals. The membrane material and pore size can be improved or optimized to selectively allow the passage of certain metal ions while retaining others, increasing the likelihood of, or ensuring, efficient extraction of the desired metal with reduced or minimal interference from non-target substances.

In some embodiments, the sorbent-based metal-extraction unit 870 includes a sorbent bed 872, where specific sorbents capture and concentrate the desired metal. Non-limiting examples of sorbent compositions used in the sorbent bed 872 include, but are not limited to, lithium manganese oxide (LMO), a lithium manganese oxide (LMO)-type lithium ion-sieve (LIS), a titanate sorbent, or an aluminate sorbent. In some embodiments, the sorbent compositions used in the sorbent bed 872 may be doped with a doping agent. Non-limiting examples of doping agents include Mg²⁺, Sn²⁺, Zn²⁺, Al³⁺, Cr³⁺, Sn⁴⁺, Zr⁴⁺, Ru⁴⁺, V⁵⁺, and/or Nb⁵⁺. The midstream-release system 854 then vacates the treated liquid resource once the metal has been extracted, leaving behind a purified solution that is free (or nearly free) of the targeted metals. This system 800 efficiently processes midstream-liquid resources, removes impurities, and extracts valuable metals, such as lithium, from the liquid resource.

Process Streams. As used herein, a “lithium-depleted fluid” is a liquid in which lithium content has been selectively reduced by a Direct Lithium Extraction (DLE) operation performed by a DLE unit (e.g., ion-exchange/adsorption on a sorbent composition, membrane-based separation, solvent extraction, electrochemical extraction, or a hybrid). A “lithium-concentrate fluid” is a liquid in which lithium is present in solution as a result of the DLE operation, for example, a retained rinse produced during a rinse, or a lithium product in solution produced as a result of running the retained rinse or lithium product in solution through a membrane-separation unit.

Water Reclamation and Reuse Loop. In some embodiments, a process stream selected from the lithium-depleted fluid or the lithium-concentrate fluid is routed to a membrane-separation station configured to perform membrane separation and to produce a permeate and retentate. The permeate is collected in a first vessel and the retentate is collected in a second vessel.

Membrane Separation Station (FO/RO/NF/UF). The membrane-separation station may comprise forward osmosis, reverse osmosis, nanofiltration, or ultrafiltration, or any combination thereof, using membranes selected from tubular, spiral-wound, flat-sheet, or osmotically assisted membranes of polymeric or ceramic construction. Operating envelopes may include a trans-membrane pressure from 100 to 1,500 psi for reverse osmosis (RO) and an osmotic-pressure differential from 5 to 150 bar for forward osmosis (FO), a trans-membrane pressure from 50 to 600 psi for NF, depending on the membrane material and solute-rejection characteristics, with feed temperatures from 5° C. to 60° C.

Feed Choices. The membrane-separation feed may comprise the lithium-depleted fluid, a rinse fluid, or the lithium-concentrate fluid. In some embodiments, the lithium-concentrate fluid comprises a lithium-brine concentrate comprising a lithium salt (e.g., lithium chloride, lithium sulfate, or lithium carbonate in solution) and is introduced to the membrane-separation station at a feed pH of 3.5 or below as measured at the membrane-separation station immediately prior to membrane separation.

Optional pH Adjustment. In some embodiments, the feed pH is adjusted to 3.5 or below before introduction to the membrane-separation station, for example by dosing an acid such as HCl or H₂SO₄.

Permeate Reuse—Plumbing. The system may include: (i) a first supply connection configured to supply at least a portion of the permeate to a rinse station as a rinse fluid; and (ii) a second supply connection configured to supply at least a portion of the permeate to a reagent station for preparing a reagent solution, with additional supply pathways optionally delivering permeate to other points of use within the DLE system (e.g., membrane-cleaning fluids, filtration backwash, electrolysis-makeup fluids, or general DLE system makeup).

Permeate—Fresh-Water Blending. In some embodiments, a vessel holding the permeate is fluidly connected to a fresh-water tank, and a controller is configured to proportion permeate and fresh water to produce a rinse fluid meeting a reuse specification.

Reuse Specification & Monitoring. A monitoring system may measure one or more of Total Dissolved Solids (TDS), conductivity, pH, turbidity, and/or temperature of the permeate at a point of reintroduction. Reintroduction is enabled when a reuse specification is satisfied, for example TDS ≤2,000 mg/L and pH between 3.0 and 8.5 for rinse service, or a reagent-specific pH window for reagent make-up.

Optional Polishing. The permeate and/or retentate may be polished using a mechanical polishing technique (e.g., sand-bed filter, carbon filter including granulated activated carbon, powdered activated carbon, extruded activated carbon, impregnated activated carbon, activated-carbon fibers, biochar, carbon-block filters, or catalytic activated carbon), a chemical polishing technique (e.g., ion-exchange media such as zeolite, manganese greensand, or synthetic resin), or a membrane filter (e.g., ultrafiltration, nanofiltration, reverse osmosis, or divalent-rejection membranes).

Routing Examples. In a sorbent-based DLE operation, a retained rinse and/or a lithium product in solution from a reagent station can be supplied to the membrane-separation station for water removal. In a membrane-based DLE operation, a lithium-rich aqueous phase produced by the membrane separation can be supplied to the membrane-separation station. In an electrochemical DLE operation, a lithium product in solution downstream of the electrochemical unit can be supplied to the membrane-separation station.

Retentate Handling. The retentate may be directed to a holding tank for further processing (e.g., additional concentration, polishing, or conversion) or to disposal consistent with facility permits, and in some embodiments at least a portion of the retentate is reintroduced within the DLE system for internal reuse, including use for alkalinity adjustment, lithium retention, ionic-strength balancing, feed blending, or recirculation within internal loops.

Control & Records. The monitoring system or a controller may actuate valves to direct membrane permeate to the rinse station and/or the reagent station, log volumes supplied via the first and second supply connections, and proportion permeate and fresh water when blending is enabled.

Geothermal Variant. In a geothermal facility, a side stream of geothermal brine can be directed to a DLE unit to produce the lithium-depleted fluid and/or the lithium-concentrate fluid. The permeate recovered from either stream can be reintroduced to the DLE rinse station and/or reagent station to reduce fresh-water draw while meeting reinjection and water-management constraints.

Ranges and Alternatives. Non-limiting ranges include: permeate recovery of 40-90%; blend ratios (permeate: fresh water) of 10:90 to 100:0 by volume; and reuse-specification TDS windows of 50-5,000 mg/L depending on service. Any of the foregoing may be implemented in batch or continuous operation.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method for recovering a fluid during operation of a direct lithium extraction (DLE) system used to extract lithium from a midstream-liquid resource and reusing the fluid within the DLE system, the method comprising:
a) recovering, from the DLE system, a process stream selected from a lithium-depleted fluid, a rinse, and a lithium-concentrate fluid, wherein the lithium-depleted fluid is a fluid in which lithium has been selectively removed by a DLE process, and wherein the lithium-concentrate fluid is a fluid in which lithium is in solution as a result of a DLE process including diffusion into a rinse and/or elution to form a lithium product in solution;
b) performing membrane separation on the recovered process stream at a membrane-separation station to produce a permeate and retentate; and
c) reintroducing at least a portion of the permeate or at least a portion of the retentate for reuse within the DLE system, and
i) wherein reintroducing at least a portion of the permeate includes use of the permeate as at least one constituent at a rinse station or reuse in preparing a reagent solution; or
ii) wherein reintroducing at least a portion of the retentate includes reuse of the retentate within the DLE system.

2. The method of claim 1, wherein the DLE process comprises ion exchange or adsorption using a sorbent composition, and placing lithium into solution comprises forming a lithium-bearing liquid during a rinse step and/or eluting lithium at a reagent station to form a lithium product in solution.

3. The method of claim 1, wherein the DLE process comprises membrane-based separation, and placing lithium into solution comprises producing the lithium-concentrate fluid as an aqueous liquid generated by the membrane-based separation or forming a lithium-bearing liquid during a rinse step.

4. The method of claim 1, wherein the DLE process comprises electrochemical extraction, and placing lithium into solution comprises producing a lithium product in solution downstream of the electrochemical extraction and/or forming a lithium-bearing liquid during a rinse step.

5. The method of claim 1, wherein the recovered process stream comprises the lithium-concentrate fluid.

6. The method of claim 1, wherein the lithium-concentrate fluid is at least one of: (i) a rinse retained after a rinse step, and (ii) a lithium product in solution formed at a reagent station.

7. The method of claim 1, wherein reintroducing comprises supplying the permeate to the rinse station as at least a portion of a rinse fluid applied by the rinse station.

8. The method of claim 1, wherein reintroducing comprises preparing a reagent solution at the reagent station using at least a portion of the permeate.

9. The method of claim 8, wherein the reagent comprises an acid selected from HCl and H₂SO₄.

10. The method of claim 1, further comprising gating reintroduction on a reuse specification comprising at least a Total Dissolved Solids (TDS) bound and a pH bound, and directing the permeate or retentate to polishing when the reuse specification is not met.

11. The method of claim 1, wherein rinsing is performed before elution or after a contact time, and at least a portion of a rinse retained after the rinse step is routed to the membrane-separation station for water removal.

12. The method of claim 1, further comprising monitoring at least TDS and pH of the permeate at the point of reintroduction and enabling reintroduction only when the reuse specification is satisfied.

13. The method of claim 1, wherein reintroducing at least a portion of the permeate further comprises using at least a portion of the permeate as a constituent of a membrane-cleaning fluid supplied to a membrane within the DLE system.

14. The method of claim 1, wherein reintroducing at least a portion of the permeate further comprises using at least a portion of the permeate as a constituent of a backwash fluid applied within the DLE system.

15. The method of claim 1, wherein reintroducing at least a portion of the permeate or retentate further comprises using at least a portion of the permeate or retentate as a constituent of an electrolysis-makeup fluid applied to an electrochemical unit within the DLE system.

16. The method of claim 1, wherein reintroducing at least a portion of the permeate or retentate further comprises using at least a portion of the permeate or retentate as a constituent of a general DLE system makeup fluid used to maintain hydraulic balance or ionic stability within the DLE system.

17. The method of claim 1, wherein reintroducing at least a portion of the retentate further comprises using at least a portion of a filtration retentate to retain lithium that would otherwise be lost to disposal.

18. The method of claim 1, wherein reintroducing at least a portion of the retentate further comprises using at least a portion of a filtration retentate to maintain or adjust ionic strength within the DLE system.

19. The method of claim 1, wherein reintroducing at least a portion of the retentate further comprises blending at least a portion of a filtration retentate with a feed stream supplied to the DLE system.

20. The method of claim 1, wherein reintroducing at least a portion of the retentate further comprises circulating at least a portion of a filtration retentate within an internal recirculation loop of the DLE system to reduce waste volume or enhance separation efficiency.
